(19) United States
(12) Patent Application Publication
(10) Pub. No.: US 2023/0091080 A1
(43) Pub. Date: Mar. 23, 2023

(54) SYSTEM INCLUDING REFLECTIVE SURFACES AND APPARATUS AND IMAGING SYSTEM INCLUDING THE SAME

(71) Applicant: CANON KABUSHIKI KAISHA, Tokyo (JP)

(72) Inventor: Keigo Yarita, Tochigi (JP)

(21) Appl. No.: 17/823,880

(22) Filed: Aug. 31, 2022

(30) Foreign Application Priority Data
Sep. 13, 2021 (JP) 2021-148754

(51) Int. Cl. G02B 17/08; H04N 5/232; G06T 7/00

(52) U.S. Cl. CPC G02B 17/0848; G06T 7/0002; H04N 5/23299; G06T 2207/10036; G06T 2207/30108; G06T 2207/30184; G06T 2207/30188

(57) ABSTRACT

A system consists of a front group, a slit member, and a rear group arranged in order from an object side to an image side, wherein the slit member is provided with an aperture long in a first direction, wherein the front group does not form an image of an object on the aperture in a first cross section parallel to the first direction, and forms an intermediate image of the object on the aperture in a second cross section perpendicular to the first direction, wherein the rear group includes a diffractive surface configured to collects a plurality of rays at positions different from each other in the second cross section, wherein the front group includes a first reflective surface and a second reflective surface that satisfies a predetermined inequality.

### BACKGROUND

### Technical Field

The aspect of the embodiments relates to an optical system used in an imaging apparatus that disperses a light beam from an object and acquires image information, and for example, is suitable for the inspection or the evaluation of a building, a crop, or a natural environment.

### Description of the Related Art

Conventionally, an optical system is known that disperses a light beam from an object (an object to be inspected) into a plurality of light beams having wavelengths different from each other and collects the light beams at positions different from each other. Japanese Patent Application Laid-Open No. 2019-215521 discusses a configuration for, in an optical system that disperses a light beam using a diffractive surface, bending an optical path using a plurality of reflective surfaces, thereby miniaturizing the entire system.

In the optical system discussed in the publication of Japanese Patent Application Laid-Open No. 2019-215521, however, if the F-number is made small to secure a sufficient amount of light and achieve high resolution, the width of the slight beam increases and eccentric aberration is likely to occur.

### SUMMARY

According to an aspect of the disclosure, a system consists of a front group, a slit member, and a rear group arranged in order from an object side to an image side, wherein the slit member is provided with an aperture that is long in a first direction, wherein the front group does not form an image of an object on the aperture in a first cross section parallel to the first direction, and forms an intermediate image of the object on the aperture in a second cross section perpendicular to the first direction, wherein the rear group includes a diffractive surface configured to disperse a light beam having passed through the aperture into a plurality of rays having wavelengths different from each other in the second cross section and collects the plurality of rays at positions different from each other in the second cross section, wherein the front group includes a plurality of reflective surfaces having powers in the second cross section, wherein the plurality of reflective surfaces consists of a first reflective surface configured to reflect a light beam having passed through an aperture of a diaphragm and a second reflective surface configured to reflect the light beam from the first reflective surface, and wherein the following inequality is satisfied: |θ1| ≤ 10.0° where in the second cross section, an extension of a principal ray passing through a center of the aperture of the diaphragm or an optical path of the principal ray is a reference axis and an angle between normals to the first and second reflective surfaces on the reference axis is θ1.

Further features of the disclosure will become apparent from the following description of exemplary embodiments with reference to the attached drawings.

### BRIEF DESCRIPTION OF THE DRAWINGS

FIG. 1 is a schematic diagram illustrating a main part of an optical system according to a first exemplary embodiment (example 1).

FIG. 2 is a schematic diagram illustrating a main part of an optical system according to a second exemplary embodiment (example 4).

FIG. 3 is a schematic diagram illustrating a main part of an optical system according to a third exemplary embodiment (example 5).

FIG. 4 is a schematic diagram illustrating a main part of an optical system according to example 2.

FIG. 5 is a schematic diagram illustrating a main part of an optical system according to example 3.

FIG. 6 is a diagram illustrating a modulated transfer function (MTF) of the optical system according to each of examples 1 to 3.

FIG. 7 is a diagram illustrating an MTF of the optical system according to each of examples 4 and 5.

FIG. 8 is a schematic diagram illustrating a main part of an imaging system according to an exemplary embodiment.

### DESCRIPTION OF THE EMBODIMENTS

With reference to the drawings, exemplary embodiments of the disclosure will be described below. The drawings may be made in sizes different from the actual sizes for descriptive purposes. In the drawings, similar members are designated by the same reference numbers, and are not redundantly described.

In the following description, an XYZ coordinate system is defined as an absolute coordinate system, and an xyz coordinate system is defined as a local coordinate system with respect to each optical surface. In the local coordinate system, the x-axis is an axis in the direction of a normal (the optical axis) at the vertex (the origin) of the optical surface, the y-axis is an axis parallel to the Y-axis and orthogonal to the x-axis at the origin, and the z-axis is an axis orthogonal to the x-axis and the y-axis. The Y-direction and the y-direction are also referred to as a “first direction (reading direction)”. The Z-direction and the z-direction are also referred to as a “second direction (spectral direction)”. The XY cross section and the xy cross section are also referred to as a “first cross section (reading cross section)”. The ZX cross section and the zx cross section are also referred to as a “second cross section (spectral cross section)”.

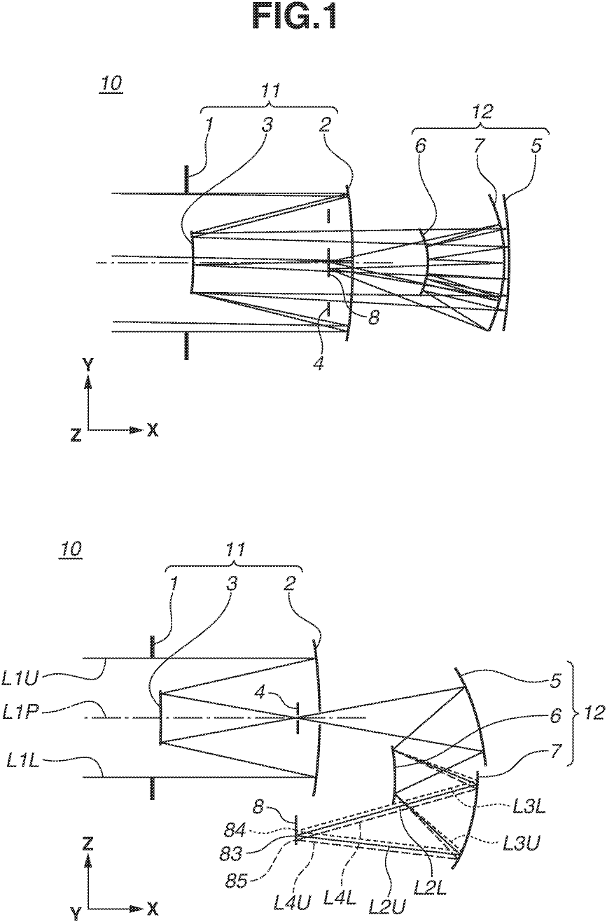

FIG. 1 is a schematic diagram illustrating a main part of an optical system 10 according to a first exemplary embodiment of the disclosure. The upper diagram of FIG. 1 illustrates the first cross section, and the lower diagram of FIG. 1 illustrates the second cross section. FIG. 1 illustrates the shapes of members in the cross sections including the optical axis, and the upper diagram of FIG. 1 illustrates the members in the same plane of the paper for descriptive purposes. In FIG. 1, a diffraction grating on a diffractive surface is omitted for descriptive purposes. In the first exemplary embodiment, an object (an object to be inspected) is placed at a position near Z = 0 at an object plane parallel to the YZ plane, and a light-receiving surface 8 of an image sensor is placed at an image plane of the optical system 10. The object is illuminated by white light (light having a plurality of wavelength components) such as sunlight.

The optical system 10 according to the first exemplary embodiment consists of a front group 11, a slit member (light-blocking member) 4, and a rear group 12 arranged in order from the object side to the image side. The optical system 10 collects a light beam from the object (not illustrated) located on the -X side, thereby forming an image of the object on the light-receiving surface (image plane) 8. Each of the front group 11 and the rear group 12 includes a plurality of reflective elements having powers in the second cross section. Specifically, the front group 11 includes a first reflective element 2 and a second reflective element 3. The rear group 12 includes a third reflective element 5, a fourth reflective element (diffractive surface) 6, and a fifth reflective element 7. In the drawings, the thickness of each reflective element (mirror) is omitted and only a reflective surface is illustrated for descriptive purposes. Thus, the following description is given by reading a “reflective element” as a “reflective surface”. Alternatively, in front of and behind the diaphragm 1, the slit member 4, or the light-receiving surface 8, an optical element such as cover glass or a filter that does not contribute to image formation may be placed.

The diaphragm 1 is a member for regulating the width of the light beam from the object and is placed so that an aperture plane of the diaphragm 1 is perpendicular to the X-direction. Although the diaphragm 1 is included in the front group 11 in the first exemplary embodiment, the diaphragm 1 may be provided outside the optical system 10. In the slit member 4, an aperture (a slit) that is long in the first direction is provided. The slit member 4 functions to limit the angle of view of the optical system 10 in the second cross section. The width of the aperture of the slit member 4 is determined according to the amount of light or the resolution. In one embodiment, the width in the second direction of the aperture of the slit member 4 is shorter than the width in the first direction (several millimeters) of the aperture of the slit member 4 and is several micrometers to several hundreds of micrometers. If the width in the second direction of the aperture of the slit member 4 is too large, the resolution of the light-receiving surface 8 decreases. If the width in the second direction of the aperture of the slit member 4 is too small, an effective light beam contributing to image formation is likely to be blocked. Thus, it is more desirable that the width in the second direction of the aperture of the slit member 4 is 10 µm or more and 200 µm or less.

Areas other than the apertures of the diaphragm 1 and the slit member 4 are light-blocking surfaces through which at least light in the use wavelength range (the design wavelength range) of the optical system 10 does not pass. As each of the diaphragm 1 and the slit member 4, a member obtained by boring a hole in a metal plate or a member obtained by depositing chromium on the surface of a glass plate can be employed. With such a slit member 4 employed, the optical system 10 can form an image of a line-shaped reading area (an area to be inspected) that is long in the first direction.

Each of the first reflective surface 2, the second reflective surface 3, the third reflective surface 5, and the fifth reflective surface 7 is a reflective surface obtained by applying reflective coating to a base surface having a freeform surface shape. The base surface of the reflective surface is formed by processing (cutting, polishing, or molding using a mold) a blocking member consisting of glass, a resin, or a metal. In one embodiment, the reflective coating has spectral reflection characteristics capable of achieving sufficient energy efficiency (light use efficiency) in the use wavelength range. If the base surface has a sufficient reflectance in the use wavelength range, the reflective coating may be omitted.

In the first exemplary embodiment, each of the first reflective surface 2, the second reflective surface 3, the third reflective surface 5, and the fifth reflective surface 7 is an aspherical surface, and specifically, is a freeform surface (an anamorphic surface) having different curvatures (powers) in the first and second cross sections. This can produce different optical actions in the first and second cross sections. Each of the reflective surfaces of the front group 11 may not be a freeform surface. For example, each of the reflective surfaces may be a spherical surface, and an anamorphic refractive surface may be provided instead. However, to reduce the number of optical surfaces in the front group 11, in one embodiment, at least one of the first reflective surface 2 and the second reflective surface 3 is a freeform surface.

The rear group 12 includes at least one diffractive surface. For example, a base surface of the diffractive surface 6 may be an aspherical surface (a freeform surface), and then, at least one of the third reflective surface 5 and the fifth reflective surface 7 may be a spherical surface or may be removed. However, to excellently correct comatic aberrations different from wavelength to wavelength that are caused by the diffractive surface 6, it is desirable to provide an optical surface other than the diffractive surface 6 in the rear group 12, and it is more desirable to place a freeform surface on the image side of the diffractive surface 6 as in the first exemplary embodiment. If the diffractive surface 6 is provided in the front group 11, only light beams of some wavelengths can pass through the aperture of the slit member 4. Thus, the diffractive surface 6 is to be provided in the rear group 12.

To divide power between optical surfaces in the optical system 10 and prevent the occurrence of aberration, it is more desirable that all the optical surfaces in the front group 11 and the rear group 12 are freeform surfaces. The configurations of the front group 11 and the rear group 12 are not limited to those described above, and the number of optical surfaces in each group may be increased or decreased. For example, to achieve a reduction in the number of components in the entire system, it is desirable to reduce the numbers of reflective surfaces included in the front group 11 and the rear group 12. If, on the other hand, the numbers of reflective surfaces included in the front group 11 and the rear group 12 are excessively reduced, it may not be possible to obtain excellent optical performance, or it may be difficult to place members so that the entire system is small. Thus, in one embodiment, the number of reflective surfaces included in the front group 11 is two and the number of reflective surfaces included in the rear group 12 is three as in the first exemplary embodiment.

In the first exemplary embodiment, all the optical surfaces included in the optical system 10 are reflective surfaces, thereby preventing the occurrence of chromatic aberration. As each reflective element (reflective member), an element (a catadioptric element) including both a reflective surface and a refractive surface, such as a prism or an inner reflective mirror (a back surface mirror), may be employed, where necessary. However, to prevent the occurrence of chromatic aberration as described above, it is desirable to configure the reflective element using an outer reflective mirror (a front surface mirror) so that a reflective surface of the reflective element is adjacent to air. At least one optical surface may be a refractive surface (a transmissive surface), where necessary.

However, particularly in the rear group 12, a holding member and wiring (not illustrated) are placed near the slit member 4 and the light-receiving surface 8. Thus, it is difficult to secure a sufficient space where a refractive element is placed. Even if the sufficient space is secured, a plurality of refractive elements is to be placed to excellently correct chromatic aberration, and therefore, the entire system becomes large. Thus, in one embodiment, at least all the optical surfaces included in the rear group 12 are reflective surfaces. Further, in another embodiment, all the optical surfaces included in the front group 11 are reflective surfaces.

The fourth reflective surface 6 is the diffractive surface 6 consisting of a base surface and a diffraction grating provided on the base surface. The base surface of the diffractive surface 6 has a freeform surface shape similarly to the other reflective surfaces. The diffraction grating consists of a plurality of grid lines (protruding portions) placed with pitches of the order of submicron to micron, and the height of each grid line is also of the order of a submicron to micron. As the diffraction grating, a diffraction grating of which the shape in the zx cross section is a stepped shape, a rectangular concavo-convex shape, a blazed shape, or a sine wave shape can be employed. The shape of the diffraction grating is selected taking into account the required diffraction efficiency and the ease of manufacturing. With a grating having a blazed cross-sectional shape, it is relatively easy to achieve both an improvement in the ease of manufacturing and an improvement in the diffraction efficiency.

The base surface of the diffractive surface 6 is formed by a method similar to those for the other reflective surfaces. The diffraction grating can be formed by processing the base surface by cutting or polishing. The diffraction grating, however, may be formed simultaneously with the formation of the base surface. For example, a fine uneven structure may be provided on the surface of a mirror surface piece forming a metal mold, and a diffractive optical element in which the diffraction grating is provided may be manufactured by molding using the metal mold.

To improve the diffraction efficiency of the diffractive surface 6, reflective coating may be applied to the surface of the diffraction grating. In one embodiment, the base surface of the diffractive surface 6 is a freeform surface (an anamorphic surface) having different curvatures in the xy cross section and the zx cross section. This can divide power between the diffractive surface 6 and another freeform surface, and therefore it is easy to correct aberration. Although the base surface of the diffractive surface 6 is a freeform surface in the first exemplary embodiment, the base surface may be formed of a flat surface or a spherical surface by attaching importance to the ease of manufacturing of the diffraction grating.

With reference to the lower diagram of FIG. 1, the action of the optical system 10 is described. The lower diagram of FIG. 1 illustrates only a principal ray L1P and marginal rays L1U and L1L in a white light beam emitted from a single point on the object (an object point). An extension of the principal ray L1P (a reference axis) is indicated by a one-dot chain line.

The light beam from the object passes through the aperture of the diaphragm 1, then is reflected by the first reflective surface 2 and the second reflective surface 3 in this order, and reaches the aperture of the slit member 4. In the first exemplary embodiment, the second reflective surface 3 is placed on the extension of the principal ray L1P passing through the center of the aperture of the diaphragm 1, and therefore, a part of the light beam is blocked by the second reflective surface 3. Specifically, the principal ray L1P having passed through the aperture of the diaphragm 1 and a ray near the principal ray L1P are blocked by the second reflective surface 3 (to be exact, the reflective element including the second reflective surface 3). The first reflective surface 2 is also placed on the extension of the principal ray L1P, and therefore, an aperture through which the light beam reflected by the second reflective surface 3 passes is provided in the first reflective surface 2. That is, the light beam reflected by the first reflective surface 2 and the second reflective surface 3 in this order passes through the aperture provided in the first reflective surface 2 and reaches the rear group 12.

The aperture of the first reflective surface 2 can be formed by, for example, boring a hole in a member forming the base surface of the first reflective surface 2. In this case, the reflective element including the first reflective surface 2 is a perforated mirror. Alternatively, the base surface of the first reflective surface 2 may be formed of a transmissive member, and reflective coating may be applied to a portion other than a portion that corresponds to the aperture. In this case, a transmissive area to which the reflective coating is not applied becomes the aperture. However, as described above, to prevent the occurrence of chromatic aberration, in one embodiment, the aperture is a hole (air) rather than a transmissive area.

In one embodiment, the aperture of the first reflective surface 2 has a size that allows the entirety of the light beam reflected by the second reflective surface 3 to pass through the aperture, and is as small as possible. To reduce the number of components, the first reflective surface 2 and the slit member 4 may be integrated together, where necessary, so that the aperture of the first reflective surface 2 and the aperture of the slit member 4 may coincide with each other. In the first exemplary embodiment, the slit member 4 is placed further on the object side than the first reflective surface 2, and therefore, the light beam reflected by the second reflective surface 3 passes through the aperture of the slit member 4 and then passes through the aperture of the first reflective surface 2. The slit member 4, however, may be placed further on the image side than the first reflective surface 2, where necessary, and the light beam reflected by the second reflective surface 3 may pass through the aperture of the first reflective surface 2 and then pass through the aperture of the slit member 4.

The front group 11 does not form an image of the object on the aperture of the slit member 4 in the first cross section (the XY cross section), and forms an intermediate image of the object on the aperture of the slit member 4 in the second cross section (the ZX cross section). Consequently, a line-shaped intermediate image (a line image) long in the first direction is formed on the aperture of the slit member 4. As used herein, “on the aperture” is not limited to the exact position of the aperture, and also includes the vicinity of the aperture slightly away from the position of the aperture in the optical axis direction (a position approximately on the aperture).

If the light beam when passing through the aperture of the slit member 4 in the first cross section is convergent light, the width of the light beam on each of the reflective surfaces in the rear group 12 becomes small, and it is difficult to improve the resolution. If, on the other hand, the light beam when passing through the aperture of the slit member 4 in the first cross section is divergent light, the width of the light beam on the aperture of the slit member 4 and the width of the light beam on the aperture of the first reflective surface 2 become greater than the width of the light beam on the second reflective surface 3. Thus, the first reflective surface 2 is to be made larger than the second reflective surface 3. Thus, the light beam reflected by the first reflective surface 2 decreases, and the light use efficiency of the entire system decreases. Thus, in one embodiment, the light beam when passing through the aperture of the slit member 4 in the first cross section is parallel light. The “parallel light” as used herein includes approximately parallel light such as weak convergent light or weak divergent light.

The light beam having passed through the aperture of the slit member 4 is dispersed into a plurality of light beams having wavelengths different from each other in the second cross section by the diffractive surface 6. At this time, since the diffraction grating on the diffractive surface 6 consists of a plurality of grid lines (ridge lines) arranged in the z-direction, the light beam incident on the diffractive surface 6 is subjected to the dispersion action in the z-direction, and is not subjected to the dispersion action in the y-direction. Then, the plurality of light beams from the diffractive surface 6 is reflected by the fifth reflective surface 7 and incident on the light-receiving surface 8 placed at the image plane. At this time, the plurality of light beams having wavelengths different from each other is collected at positions different from each other on the light-receiving surface 8 in the second cross section. That is, based on the optical system 10 according to the first exemplary embodiment, it is possible to form a plurality of images at respective wavelengths on the light-receiving surface 8. Thus, the light-receiving surface 8 can acquire a plurality of pieces of image information at respective wavelengths.

As described above, the optical system 10 according to the first exemplary embodiment produces different optical actions in the first cross section including the reading direction and the second cross section including the spectral direction. Specifically, in the first cross section, the optical system 10 does not form an image of the object once on the aperture of the slit member 4, and forms an image of the object on the light-receiving surface 8. In the second cross section, however, the optical system 10 forms an image of the object once on the aperture of the slit member 4 and then forms an image of the object again on the light-receiving surface 8. That is, the optical system 10 forms an image of the object once in the first cross section, while the optical system 10 forms an image of the object twice in the second cross section. According to this configuration, the convergence state of the light beam when passing through the aperture of the slit member 4 (the light beam incident on the aperture) is not limited in the first cross section. Thus, it is possible to improve the degree of freedom in designing the optical system 10. Thus, it is possible to form an image of the object to be inspected on the light-receiving surface 8 by appropriately dividing power between the front group 11 and the rear group 12, and it is easy to correct various aberrations. Thus, it is possible to achieve both a wide angle of view (a wide reading area) and high definition of a captured image.

Next, a description is given of the state where the light beam is dispersed by the diffractive surface 6. A case is considered where a white light beam emitted from a single point on the object is dispersed into light beams of wavelengths λ1 [nm], λ2 [nm], and λ3 [nm] (λ2 < λ1 < λ3).

The marginal rays L1U and L1L of the light beam from the object pass through the diaphragm 1, the first reflective surface 2, and the second reflective surface 3 in this order and form a line-shaped intermediate image on the aperture of the slit member 4. As described above, the principal ray L1P is blocked by the second reflective surface 3, and therefore does not reach the aperture of the slit member 4. The marginal rays L1U and L1L having passed through the aperture of the slit member 4 are reflected by the reflective surface 5 and then dispersed into rays L2U and L2L of the wavelength λ1, rays L3U and L3L of the wavelength λ2, and rays L4U and L4L of the wavelength λ3 by the diffractive surface 6. Then, the rays of the wavelengths λ1, λ2, and λ3 are collected at a first position 83, a second position 84, and a third position 85, respectively, on the light-receiving surface 8.

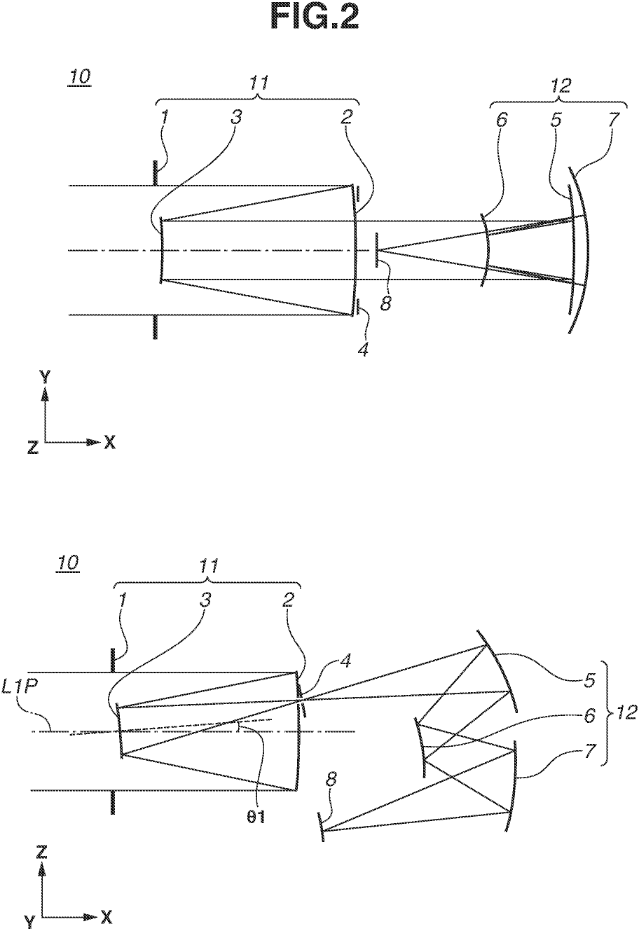

In a case where the extension of the principal ray L1P is the reference axis, the aperture of the first reflective surface 2 according to the first exemplary embodiment is provided on the reference axis, but the aperture of the first reflective surface 2 may be provided at a position different from that on the reference axis, where necessary. FIG. 2 is a schematic diagram illustrating a main part of an optical system 10 according to a second exemplary embodiment of the disclosure. The upper diagram of FIG. 2 illustrates the first cross section, and the lower diagram of FIG. 2 illustrates the second cross section. The optical system 10 according to the second exemplary embodiment is different from that according to the first exemplary embodiment in that a normal to the second reflective surface 3 on the reference axis is inclined (tilted) to the reference axis.

In the second exemplary embodiment, the second reflective surface 3 is tilted counterclockwise in the second cross section, and therefore, the light beam reflected by the second reflective surface 3 reaches a portion on the uppers side (on the +Z side than) the reference axis on the first reflective surface 2. Thus, the aperture of the first reflective surface 2 is provided on the upper side of the reference axis. Consequently, the reflective surfaces in the rear group 12 and the light-receiving surface 8 are placed further on the upper side than in the first exemplary embodiment. As described above, the tilt angle of the second reflective surface 3 (the angle between a surface normal on the reference axis and the reference axis) and the position of the aperture of the first reflective surface 2 can be appropriately set taking into account the placement of the reflective surfaces in the rear group 12 and the light-receiving surface 8. However, to more excellently correct eccentric aberration, it is desirable to place the aperture of the first reflective surface 2 on the reference axis without tilting the second reflective surface 3 as in the first exemplary embodiment. It is also desirable to provide the aperture of the slit member 4 on the normal to the first reflective surface 2 on the reference axis.

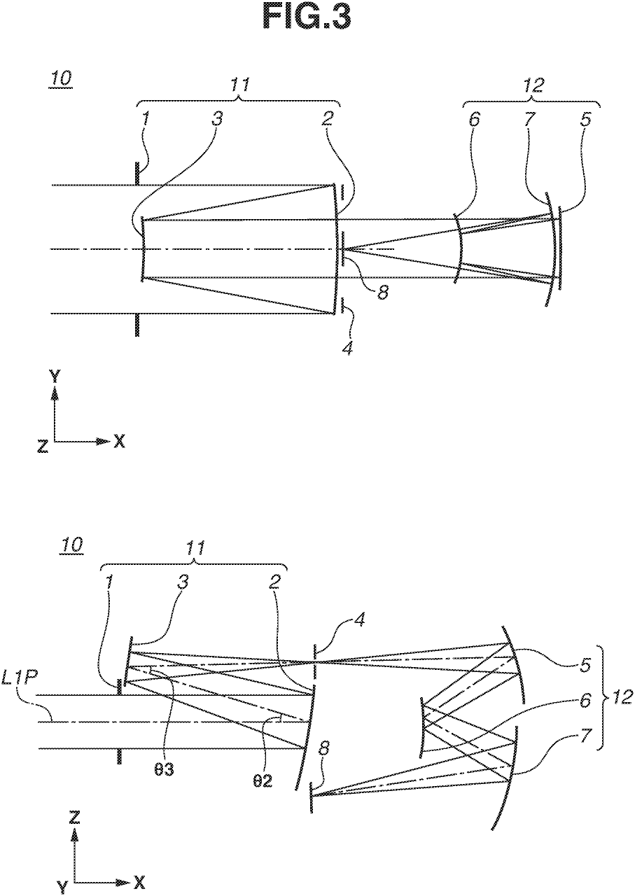

As described above, although the principal ray L1P is reflected by the second reflective surface 3 in the first exemplary embodiment, the placement of the first reflective surface 2 and the second reflective surface 3 may be changed, where necessary, so that the principal ray L1P is reflected by each of the reflective surfaces and then reaches the aperture of the slit member 4. FIG. 3 is a schematic diagram of a main part of an optical system 10 according to a third exemplary embodiment of the disclosure. The upper diagram of FIG. 3 illustrates the first cross section, and the lower diagram of the FIG. 3 illustrates the second cross section. The optical system 10 according to the third exemplary embodiment is different from that according to the first exemplary embodiment in that the principal ray L1P is reflected by the first reflective surface 2 and the second reflective surface 3.

In the third exemplary embodiment, the second reflective surface 3 is placed by shifting the second reflective surface 3 to the upper side (the +Z side) in the second cross section to prevent the principal ray L1P from being blocked by the second reflective surface 3. To reflect the principal ray L1P toward the second reflective surface 3, the first reflective surface 2 is also tilted clockwise. According to this configuration, the entirety of the light beam from the diaphragm 1 can be reflected by each of the reflective surfaces. Thus, it is not necessary to provide an aperture in the second reflective surface 3. The rear group 12 can also be placed to largely overlap the first reflective surface 2 when viewed from the -X-direction. Thus, it is possible to further miniaturize the entire system in the Z-direction. However, to more excellently correct eccentric aberration, it is desirable to place the first reflective surface 2 and the second reflective surface 3 on the extension of the principal ray L1P passing through the aperture of the diaphragm 1 as in the first exemplary embodiment.

Next, the placement of the reflective surfaces included in the optical system 10 is described in detail.

As described above, in the optical system discussed in Japanese Patent Application Laid-Open No. 2019-215521, due to the influence of the bending of the optical path for miniaturization, eccentric aberration is likely to occur when the F-number is made small. Thus, for example, in a case where the optical system is a telephoto system, it is difficult to achieve high resolution by making the F-number sufficiently small. In response, in each of the exemplary embodiments, the optical system 10 is configured so that the following inequality (1) is satisfied where in the second cross section, the angle between the normals to the first reflective surface 2 and the second reflective surface 3 on the reference axis is θ1.

In the configuration in which the principal ray L1P is not incident on the first reflective surface 2 and the second reflective surface 3 as in the first and second exemplary embodiments, the extension of the principal ray L1P is the reference axis. On the other hand, in the configuration in which the principal ray L1P is incident on the first reflective surface 2 and the second reflective surface 3 as in the third exemplary embodiment, the optical path of the principal ray L1P is the reference axis. In the configuration in which an aperture is provided at the position of the reference axis on the first reflective surface 2 as in the first exemplary embodiment, the normal is defined on the assumption that the first reflective surface 2 is a continuous surface in which the aperture is not provided. In other words, a normal to an extended surface of the first reflective surface 2 on the reference axis is regarded as the normal to the first reflective surface 2 on the reference axis.

$$\left|θ 1\right| \leq 10.0 °$$

Inequality (1) is satisfied, whereby it is possible to prevent the occurrence of eccentric aberration on the reflective surfaces. Consequently, even in a case where the focal length is made large or the F-number is made small in the second cross section, it is possible to achieve high resolution. If |θ1| exceeds the upper limit of inequality (1), it is difficult to sufficiently prevent the occurrence of eccentric aberration.

Further, it is more desirable to satisfy the following inequalities (1a) and (1b) and equality (1c) in order.

$$\left|θ 1\right| \leq 5.3 °$$

$$\left|θ 1\right| \leq 2.0 °$$

$$\left|θ 1\right| = 0.0 °$$

In the optical system 10 according to the first exemplary embodiment, the front group 11 is a completely coaxial system, and the normals to the first reflective surface 2 and the second reflective surface 3 on the reference axis coincide with each other. Thus, |θ1| = 0.0°. Consequently, it is possible to prevent the occurrence of eccentric aberration more excellently than in a case where the front group 11 is a non-coaxial system. However, even if the front group 11 is not a completely coaxial system, the effect of the disclosure can be obtained by at least satisfying inequality (1).

To prevent the occurrence of eccentric aberration in the configuration in which the principal ray L1P is reflected by the first reflective surface 2 and the second reflective surface 3 as in the third exemplary embodiment, the reflective surfaces is placed so that the relationship between the incidence angle and the reflection angle of the principal ray L1P is appropriate. In response, in the third exemplary embodiment, the optical system 10 is configured so that the following inequality (2) is satisfied where in the second cross section, the sum of the incidence angle and the reflection angle of the principal ray L1P on the first reflective surface 2 is θ2 and the sum of the incidence angle and the reflection angle of the principal ray L1P on the second reflective surface 3 is θ3. Both the incidence angle and the reflection angle on each reflective surface have positive values.

$$\left|θ 2 \text{-} θ \text{3}\right| \leq 20.0 °$$

Inequality (2) is satisfied, whereby, even in a case where the front group 11 is a non-coaxial system, it is possible to prevent the occurrence of eccentric aberration on each of the reflective surfaces similarly to the case where inequality (1) is satisfied. If |θ2 - θ3| exceeds the upper limit of inequality (2), it is difficult to sufficiently prevent the occurrence of eccentric aberration in the configuration in which the principal ray L1P is reflected by the first reflective surface 2 and the second reflective surface 3.

Further, it is more desirable to satisfy the following inequalities (2a) and (2b) and equality (2c) in order.

$$\left|θ 2 \text{-} θ 3\right| \leq 10.6 °$$

$$\left|θ 2 \text{-} θ 3\right| \leq 4.0 °$$

$$\left|θ 2 \text{-} θ 3\right| \leq 0.0 °$$

It is desirable to satisfy the following inequality (3) where in the first cross section, the width of the light beam having passed through the aperture of the diaphragm 1 on the second reflective surface 3 is w2 and the width of the light beam on the aperture of the slit member 4 is w3.

$$0.70 \leq \text{w2} / \text{w3} \leq \text{1} \text{.30}$$

Inequality (3) is satisfied, whereby the light beam when passing through the aperture of the slit member 4 is parallel light in the first cross section. Thus, as described above, it is possible to achieve sufficient resolution and light use efficiency. If w2/w3 exceeds the upper limit of inequality (3), the light beam passing through the aperture of the slit member 4 is convergent light, and it is difficult to achieve sufficient resolution. If w2/w3 falls below the lower limit of inequality (3), the light beam passing through the aperture of the slit member 4 is divergent light, and it is difficult to achieve sufficient light use efficiency.

Further, it is more desirable to satisfy the following inequalities (3a) and (3b) in order.

$$0.80 \leq \text{w2} / \text{w3} \leq \text{1} \text{.20}$$

$$0.85 \leq \text{w2} / \text{w3} \leq \text{1} \text{.13}$$

As described above, the optical system 10 according to each of the first and second exemplary embodiments employs the configuration in which an aperture is provided in the first reflective surface 2 and the light beam reflected by the second reflective surface 3 passes through the apertures of the first reflective surface 2 and the slit member 4. In such a configuration, if the distance between the first reflective surface 2 and the slit member 4, i.e., the distance between the centers of the apertures of the first reflective surface 2 and the slit member 4, is large, the width of the light beam when incident on the aperture of the first reflective surface 2 is large. Thus, the aperture of the first reflective surface 2 is to be made large. This leads to a decrease in the light use efficiency.

In response, it is desirable to configure the optical system 10 so that the following inequality (4) is satisfied where the distance between a point on the reference axis on the first reflective surface 2 and the center of the aperture of the slit member 4 is L1 and the distance between a point on the reference axis on the second reflective surface 3 and the center of the aperture of the slit member 4 is L2. Both the distances L1 and L2 have positive values. In the configuration in which an aperture is provided at the position of the reference axis on the first reflective surface 2 as in the first exemplary embodiment, the point is defined on the assumption that the first reflective surface 2 is a continuous surface in which the aperture is not provided. In other words, a point on the reference axis on an extended surface of the first reflective surface 2 is regarded as the point on the reference axis on the first reflective surface 2.

$$0.0 \leq \text{L1} / \text{L2} \leq \text{0} \text{.5}$$

Inequality (4) is satisfied, whereby the distance between the first reflective surface 2 and the slit member 4 is sufficiently small. Thus, it is possible to secure a sufficient amount of light on the light-receiving surface 8. If L1/L2 exceeds the upper limit of inequality (4), the amount of light of the light beam reflected by the first reflective surface 2 decreases. Thus, it is difficult to secure a sufficient amount of light on the light-receiving surface 8. Since both the distances L1 and L2 have positive values, L1/L2 does not fall below the lower limit of inequality (4).

Further, it is more desirable to satisfy the following inequalities (4a) and (4b) in order.

$$0.0 \leq \text{L1} / \text{L2} \leq \text{0} \text{.4}$$

$$0.0 \leq \text{L1} / \text{L2} \leq \text{0} \text{.2}$$

It is desirable to configure the optical system 10 so that the following inequality (5) is satisfied where the distance between a point on the reference axis on the third reflective surface 5 and the center of the aperture of the slit member 4 is L3.

$$0.60 \leq \text{L2} / \text{L3} \leq \text{1} \text{.85}$$

Inequality (5) is satisfied, whereby it is possible to appropriately set the positional relationships between the second reflective surface 3 closest to the image plane on an optical path in the front group 11 and the third reflective surface 5 closest to the object on an optical path in the rear group 12 and the slit member 4. If L2/L3 exceeds the upper limit of inequality (5), the width of the light beam in the rear group 12 in the second cross section is too small, and thus it is difficult to improve the resolution. If L2/L3 falls below the lower limit of inequality (5), the width of the light beam in the rear group 12 is too large, and thus it is difficult to miniaturize the optical system 10.

Further, it is more desirable to satisfy the following inequalities (5a) and (5b) in order.

$$0.68 \leq \text{L2} / \text{L3} \leq 1. \text{79}$$

$$0.75 \leq \text{L2} / \text{L3} \leq \text{1} \text{.63}$$

It is desirable to configure the optical system 10 so that the following inequality (6) is satisfied where in the first cross section, the power of the third reflective surface 5 is φ1 and the power of the fifth reflective surface 7 is φ2.

$$1.60 \leq φ 2 / φ 1 \leq 2.50$$

Inequality (6) is satisfied, whereby the ratio between the powers of the third reflective surface 5 and the fifth reflective surface 7 in the first cross section is appropriately set, and it is possible to achieve high resolution of the optical system 10. If φ2/φ1 exceeds the upper limit of inequality (6), the power of the fifth reflective surface 7 in the first cross section is too strong for the power of the third reflective surface 5, and it is difficult to correct aberration in the rear group 12. Thus, it is difficult to achieve high resolution. If φ2/φ1 falls below the lower limit of inequality (6), the F-number of the optical system 10 is too large, and it is difficult to achieve high resolution.

Further, it is more desirable to satisfy the following inequalities (6a) and (6b) in order.

$$1.74 \leq φ 2 / φ 1 \leq 2.32$$

$$1.93 \leq φ 2 / φ 1 \leq 2.11$$

It is desirable to configure the optical system 10 so that the following inequality (7) is satisfied where in the second cross section, the power of the third reflective surface 5 is φ3 and the power of the fourth reflective surface 6 is φ4.

$$\text{-} 2.4 \leq φ 4 / φ 3 \leq \text{-} 1.4$$

Inequality (7) is satisfied, whereby the ratio between the powers of the third reflective surface 5 and the fourth reflective surface 6 in the second cross section is appropriately set, and it is possible to achieve high resolution of the optical system 10. If inequality (7) is not satisfied, it is difficult to sufficiently prevent the occurrence of eccentric aberration in the rear group 12. Thus, it is difficult to achieve high resolution.

Further, it is more desirable to satisfy the following inequalities (7a) and (7b) in order.

$$\text{-} 2.2 \leq φ 4 / φ 3 \leq \text{-} 1.5$$

$$\text{-} 2.0 \leq φ 4 / φ 3 \leq \text{-} 1.6$$

In one embodiment, the signs of the powers of the reflective surfaces included in the rear group 12 in the second cross section are positive, negative, and positive in order from the object side. Specifically, in one embodiment, in the second cross section, the third reflective surface 5 has a positive power, the fourth reflective surface 6 has a negative power, and the fifth reflective surface 7 has a positive power. Consequently, an optical path from the slit member 4 to the light-receiving surface 8 in the second cross section can be approximately symmetrical in the Z-direction. Thus, it is possible to achieve both the miniaturization of the entire system and excellent optical performance.

As described above, based on the optical system 10 according to each of the exemplary embodiments, it is possible to achieve both the miniaturization of the entire system and the prevention of the occurrence of eccentric aberration.

### Example 1

An optical system 10 according to example 1 of the disclosure is described below. The optical system 10 according to the present example employs a configuration equivalent to that of the optical system 10 according to the first exemplary embodiment.

In the present example, the distance from the object to the diaphragm 1 (the object distance) is 500 km, and the width in the first direction of a reading area is 19.2 km. The use wavelength range is from 380 nm to 1120 nm, and the width in the second direction of an image formation area (an incidence area) of the light beam on the light-receiving surface 8 is 3.94 mm.

Expression formulae for the surface shapes of the optical surfaces of the optical system 10 according to the present example are described. The expression formulae for the surface shapes of the optical surfaces are not limited to those described below, and the optical surfaces may be designed using other expression formulae, where necessary.

The shape in the first cross section (the meridional shape) of the base surface of each of the first reflective surface 2, the second reflective surface 3, the third reflective surface 5, the fourth reflective surface (diffractive surface) 6, and the fifth reflective surface 7 according to the present example is represented by the following formula (1) in the corresponding local coordinate system.

$$x = \frac{{y}^{2} / {R}_{y}}{1 + \sqrt{1 - \left(1 + {K}_{y}\right) {\left(y / {R}_{y}\right)}^{2}}} + {B}_{2} {y}^{2} + {B}_{4} {y}^{4} + {B}_{6} {y}^{6} + {B}_{8} {y}^{8}$$

R_{y} is the radius of curvature in the xy cross section (the meridional radius of curvature), and K_{y}, B₂, B₄, B₆, and B₈ are aspherical surface coefficients in the xy cross section. The numerical values of each of the aspherical surface coefficients B₂, B₄, B₆, and B₈ may be different from each other on both sides (the -y side and the +y side) of the x-axis, where necessary. Consequently, the meridional shape can be a shape asymmetrical in the y-direction with respect to the x-axis. Although second-order to eighth-order aspherical surface coefficients are used in the present example, a higher-order aspherical surface coefficient may be used, where necessary.

The shape in the second cross section (the sagittal shape) at any position in the y-direction of the base surface of each of the optical surfaces according to the present example is represented by the following formula (2).

$$s = \frac{{z}^{r} / r '}{1 + \sqrt{1 - \left(1 + {K}_{2}\right) {\left(z / r ′\right)}^{2}}} + \sum \sum {M}_{j k} {y}^{j} {z}^{k}$$

K_{z} and Mⱼₖ are aspherical surface coefficients in the zx cross section. The denotation r′ represents the radius of curvature in a cross section perpendicular to the meridional direction at a position away from the optical axis by y in the y-direction (the sagittal radius of curvature) and is given by the following formula (3).

$$\frac{1}{{r}^{′}} = \frac{1}{r} + {E}_{2} {y}^{2} + {E}_{4} {y}^{4}$$

The denotation r represents the sagittal radius of curvature on the optical axis, and E₂ and E₄ are sagittal change coefficients. If r = 0 in formula (3), the first term on the right side of formula (2) is treated as zero. Each of the sagittal change coefficients E₂ and E₄ may have different numerical values on the -y side and the +y side, where necessary. Consequently, the aspherical surface amount of the sagittal shape can be asymmetrical in the y-direction. Although formula (3) includes even number terms, an odd number term may be added, where necessary. A higher-order sagittal change coefficient may be also used, where necessary.

The first-order term of z in formula (2) is a term contributing to the tilt amount of the optical surface in the zx cross section (the sagittal tilt amount). Thus, if the numerical values of Mⱼₖ are made different from each other on the -y side and the +y side, the sagittal tilt amount can be asymmetrically changed in the y-direction. Alternatively, the sagittal tilt amount may be asymmetrically changed by using an odd number term. The second-order term of z in formula (2) is a term contributing to the sagittal radius of curvature of the optical surface. Thus, to simplify the design of each optical surface, the sagittal radius of curvature may be given to the optical surface using the second-order term of z in formula (2), not formula (3).

The shape of the diffraction grating on the diffractive surface 5 is not particularly limited so long as the shape is represented by a phase function that is based on a known diffractive optical theory. In the present example, the shape of the diffraction grating on the diffractive surface 5 is defined by the following phase function φ where a reference wavelength (a design wavelength) is λ [mm] and phase coefficients in the zx cross section are C1, C2, and C3. In the present exemplary embodiment, the diffraction order of the diffraction grating is -1.

$$φ = \left(2 π / λ\right) \times \left(\text{C1} \times \text{z} \text{+} \text{C2} \times {\text{z}}^{2} + \text{C3} \times {\text{z}}^{3}\right)$$

The reference wavelength is a wavelength for determining the height of the diffraction grating and is determined based on the spectral characteristics of light illuminating the object, the spectral reflectance of the reflective surface of the diffractive surface 6, the spectral light-receiving sensitivity of the image sensor including the light-receiving surface 8, and the required diffraction efficiency. That is, the reference wavelength corresponds to a wavelength to which importance should be attached when the wavelength is detected using the light-receiving surface 8. In the present example, the reference wavelength λ is 542 nm, whereby it is possible to focus on the observation of the visible range in the use wavelength range.

Alternatively, the reference wavelength may be about 850 nm, for example, whereby it is possible to focus on the observation of the near-infrared range. Yet alternatively, the reference wavelength may be about 700 nm, whereby it is possible to observe a range from the visible range to the near-infrared range in a balanced manner.

Table 1 illustrates the values of the focal length [mm] on the image side, the F-number (Fno) on the image side, and the image forming magnification of the optical system 10 according to the present example. Since the optical system 10 is an anamorphic optical system, table 1 illustrates the values in both the first cross section (the reading cross section) and the second cross section (the spectral cross section). Since the optical system 10 forms an intermediate image on the aperture of the slit member 4 in the second cross section, table 1 illustrates the focal length of each of the front group 11 and the rear group 12. In the following tables, “E±*” represents “x 10^{±}*”.

Table 1

| | | |
|---|---|---|
| | Reading cross section | Spectral cross section |
| Focal length (image side) | 245.3 | 263.0 |
| | | 1501.9 |
| Fno (image side) | 2.3 | 2.4 |
| Image forming magnification | 4.81E-07 | 4.80E-07 |

Table 2 illustrates the position of the vertex, the direction of the normal at the vertex, and the radius of curvature in each cross section of each of the optical surfaces of the optical system 10 according to the present example. In table 2, the position of the vertex of each optical surface is represented by distances X, Y, and Z [mm] from the origin in the absolute coordinate system, and the direction of the normal (the x-axis) is represented by an angle θ [deg] to respect to the X-axis in the ZX cross section including the optical axis. The denotation d [mm] represents the distance between optical surfaces (the surface distance), and the denotation d′ [mm] represents the distance between reflection points of the principal ray on each optical surface. The denotations R_{y} and R_{z} represent the radii of curvature in the XY cross section and the ZX cross section, respectively, at the reflection points of the principal ray. If the value of the radius of curvature of each reflective surface is positive, this indicates a concave surface. If the value of the radius of curvature of each reflective surface is negative, this indicates a convex surface.

Table 2

| | | X | Y | Z | θ | d | d′ | Ry | Rz |
|---|---|---|---|---|---|---|---|---|---|
| Diaphragm | 1 | - 85.210 | 0.000 | 0.000 | 0.000 | 125.054 | 125.054 | | |
| First reflective surface | 2 | 39.844 | 0.00 | 0.000 | 180.000 | 119.835 | 119.835 | 424.084 | 393.233 |
| Second reflective surface | 3 | -79.991 | 0.000 | 0.000 | 0.000 | 102.551 | 102.551 | -175.217 | - 4608.59 |
| Slit member | 4 | 22.56 | 0.000 | 0.000 | 0.000 | 135.961 | 136.544 | | |
| Third reflective surface | 5 | 158.506 | 0.000 | 1.988 | 162.892 | 76.117 | 73.539 | 250.254 | 156.065 |
| Fourth reflective surface | 6 | 97.272 | 0.000 | - 43.225 | 0.000 | 67.386 | 67.794 | - 47.893 | - 101.534 |
| Fifth reflective surface | 7 | 154.653 | 0.000 | - 78.557 | 194.697 | 132.171 | 133.632 | 118.835 | 147.743 |
| Light-receiving surface | 8 | 22.610 | 0.000 | - 84.390 | 0.000 | | | | |

Table 3 illustrates the surface shapes of the optical surfaces of the optical system 10 according to the present example.

Table 3

| | | | | | |
|---|---|---|---|---|---|
| | First reflective surface | Second reflective surface | Third reflective surface | Fourth reflective surface | Fifth reflective surface |
| R _{y} | 4.241E+02 | -1.752E+02 | 2.500E+02 | -4.852E+01 | 1.187E+02 |
| K _{y} | -1.583E+00 | -2.144E-01 | -1.000E+00 | -1.000E+00 | -1.000E+00 |
| B ₂ | 0.000E+00 | 0.000E+00 | 0.000E+00 | 0.000E+00 | 0.000E+00 |
| B ₄ | 2.060E-09 | -2.863E-08 | -3.344E-08 | -3.862E-08 | 6.210E-08 |
| B ₆ | -1.050E-13 | 3.038E-11 | -5.852E-12 | 2.825E-10 | 1.711E-12 |
| B ₈ | 0.000E+00 | 0.000E+00 | 0.000E+00 | 0.000E+00 | 0.000E+00 |
| r | 0.000E+00 | 0.000E+00 | 0.000E+00 | 0.000E+00 | 0.000E+00 |
| K _{Z} | 0.000E+00 | 0.000E+00 | 0.000E+00 | 0.000E+00 | 0.000E+00 |
| E₂ | 0.000E+00 | 0.000E+00 | 0.000E+00 | 0.000E+00 | 0.000E+00 |
| E₄ | 0.000E+00 | 0.000E+00 | 0.000E+00 | 0.000E+00 | 0.000E+00 |
| M ₀₁ | 0.000E+00 | 0.000E+00 | 0.000E+00 | 0.000E+00 | 0.000E+00 |
| M ₂1 | 0.000E+00 | 0.000E+00 | -1.139E-06 | -3.655E-05 | 8.645E-07 |
| M ₄₁ | 0.000E+00 | 0.000E+00 | 1.782E-10 | -3.515E-09 | -2.233E-11 |
| M ₆₁ | 0.000E+00 | 0.000E+00 | 0.000E+00 | 0.000E+00 | -5.622E-15 |
| M ₀₂ | 1.272E-03 | -8.216E-04 | 3.212E-03 | -4.790E-03 | 3.379E-03 |
| M ₂₂ | 9.057E-10 | -2.424E-07 | 6.408E-08 | -1.118E-07 | -1.714E-09 |
| M ₄₂ | 7.333E-13 | 1.080E-10 | 2.078E-12 | -5.567E-10 | 1.622E-12 |
| M ₆₂ | -2.027E-16 | -7.099E-14 | 0.000E+00 | 0.000E+00 | 1.413E-16 |
| M ₀₃ | 0.000E+00 | 0.000E+00 | -1.060E-06 | -1.518E-05 | -3.321E-07 |
| M ₂₃ | 0.000E+00 | 0.000E+00 | -8.388E-10 | 1.294E-08 | 6.509E-12 |
| M ₄₃ | 0.000E+00 | 0.000E+00 | 1.316E-13 | -1.174E-11 | 5.266E-14 |
| M ₆₃ | 0.000E+00 | 0.000E+00 | 0.000E+00 | 0.000E+00 | 0.000E+00 |
| M ₀₄ | -1.346E-08 | 6.025E-07 | -3.089E-08 | 2.312E-07 | 4.295E-08 |
| M ₂₄ | 3.252E-12 | -3.585E-10 | 3.486E-11 | -1.803E-10 | -1.144E-12 |
| M ₄₄ | -1.045E-15 | -1.198E-13 | -1.068E-14 | 9.789E-13 | -6.447E-16 |
| M ₆₄ | 1.705E-19 | 2.126E-16 | 0.000E+00 | 0.000E+00 | 0.000E+00 |
| M ₀₅ | 0.000E+00 | 0.000E+00 | 0.000E+00 | 0.000E+00 | -1.937E-11 |
| M ₂₅ | 0.000E+00 | 0.000E+00 | 0.000E+00 | 0.000E+00 | 1.564E-14 |
| M ₄₅ | 0.000E+00 | 0.000E+00 | 0.000E+00 | 0.000E+00 | -2.578E-17 |
| M ₆₅ | 0.000E+00 | 0.000E+00 | 0.000E+00 | 0.000E+00 | 0.000E+00 |
| M ₀₆ | -4.748E-14 | -2.113E-10 | 0.000E+00 | 0.000E+00 | 2.291E-13 |
| M ₂₆ | -3.281E-16 | 1.177E-13 | 0.000E+00 | 0.000E+00 | 4.896E-16 |
| M ₄₆ | 9.650E-20 | 5.981E-16 | 0.000E+00 | 0.000E+00 | 3.196E-19 |
| M ₆₆ | 0.000E+00 | 0.000E+00 | 0.000E+00 | 0.000E+00 | 0.000E+00 |

Table 4 illustrates the various numerical values of the fourth reflective surface (diffractive surface) 6 of the optical system 10 according to the present example.

Table 4

| | C1 | C2 | C3 | Reference wavelength | Diffraction order |
|---|---|---|---|---|---|
| Fourth reflective surface | 1.50E-02 | 1.33E-05 | -3.05E-08 | 542 | -1 |

Table 5 illustrates the diameters [mm] in the y-direction and the z-direction of the aperture of the diaphragm 1, the aperture of the slit member 4, and the light-receiving surface 8. In the present example, the aperture of the diaphragm 1 is circular, and the apertures of the slit member 4 and the light-receiving surface 8 are rectangular. The diameter of the aperture of the diaphragm 1 in table 5 indicates the radius.

Table 5

| | Diaphragm | Slit member | Light-receiving surface |
|---|---|---|---|
| Diameter (y) | 52 | 30 | 7.2 |
| Diameter (z) | 52 | 0.05 | 5.4 |

### Example 2

An optical system 10 according to example 2 of the disclosure is described below. In the optical system 10 according to the present example, a description of a configuration equivalent to that of the optical system 10 according to example 1 described above is omitted.

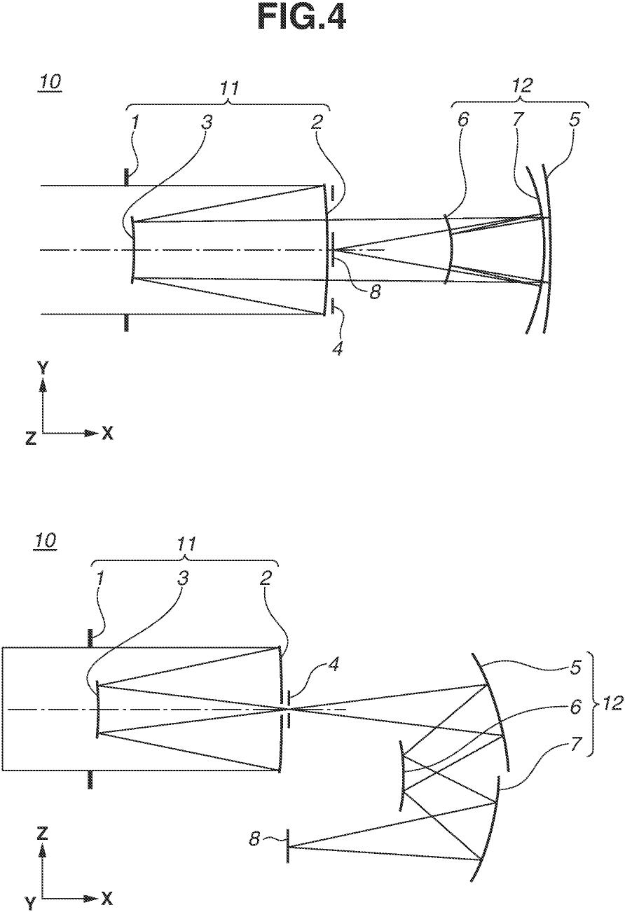

FIG. 4 is a schematic diagram of a main part of the optical system 10 according to the present example. The upper diagram of FIG. 4 illustrates the first cross section, and the lower diagram of FIG. 4 illustrates the second cross section. In the optical system 10 according to the present example, unlike example 1, the slit member 4 is placed on the image side of the first reflective surface 2. Consequently, the length of an optical path from the second reflective surface 3 to the slit member 4 is longer than that in example 1, thereby achieving a reduction in the size of the slit member 4.

In the present example, the distance from the object to the diaphragm 1 is 500 km, and the width in the first direction of a reading area is 19.2 km. In the present example, the use wavelength range is from 380 nm to 1120 nm, and the width in the second direction of an image formation area of the light beam on the light-receiving surface 8 is 3.94 mm.

Similarly to example 1, table 6 illustrates the optical characteristics of the optical system 10 according to the present example. Table 7 illustrates the various numerical values of each of the optical surfaces. Table 8 illustrates the surface shapes of the optical surfaces. Table 9 illustrates the various numerical values of the diffractive surface 6. Table 10 illustrates the diameters of the aperture of the diaphragm 1, the aperture of the slit member 4, and the light-receiving surface 8.

Table 6

| | | |
|---|---|---|
| | Reading cross section | Spectral cross section |
| Focal length (image side) | 237.7 | 354.2 |
| | | 1590.9 |
| Fno (image side) | 3.0 | 3.7 |
| Image forming magnification | 4.80E-07 | 4.80E-07 |

Table 7

| | | X | Y | Z | θ | d | d′ | R_{y} | R_{z} |
|---|---|---|---|---|---|---|---|---|---|
| Diaphragm | 1 | - 85.210 | 0.000 | 0.000 | 0.000 | 124.210 | 124.210 | | |
| First reflective surface | 2 | 39.000 | 0.000 | 0.000 | 180.000 | 120.140 | 120.140 | 425.210 | 368.820 |
| Second reflective surface | 3 | - 81.140 | 0.000 | 0.000 | 0.000 | 123.700 | 123.700 | 175.846 | - 268.157 |
| Slit member | 4 | 42.560 | 0.000 | 0.000 | 0.000 | 135.946 | 135.946 | | |
| Third reflective surface | 5 | 178.506 | 0.000 | 0.000 | 162.828 | 74.542 | 73.570 | 254.148 | 158.100 |
| Fourth reflective surface | 6 | 117.776 | 0.000 | - 43.225 | 0.000 | 66.957 | 68.232 | - 49.736 | - 105.848 |
| Fifth reflective surface | 7 | 174.653 | 0.000 | - 78.557 | 194.364 | 132.171 | 132.161 | 119.350 | 147.017 |
| Light-receiving surface | 8 | 42.610 | 0.000 | - 84.390 | 0.000 | | | | |

Table 8

| | | | | | |
|---|---|---|---|---|---|
| | First reflective surface | Second reflective surface | Third reflective surface | Fourth reflective surface | Fifth reflective surface |
| R _{y} | 4.252E+02 | -1.758E+02 | 2.541E+02 | -4.974E+01 | 1.193E+02 |
| K _{y} | 7.831E-01 | -8.553E+00 | -1.000E+00 | -1.000E+00 | -1.000E+00 |
| B ₂ | 0.000E+00 | 0.000E+00 | 0.00013+00 | 0.000E+00 | 0.000E+00 |
| B ₄ | -3.140E-09 | -1.728E-07 | -4.594E-08 | 4.966E-08 | 6.220E-08 |
| B ₆ | -1.301E-13 | 7.786E-11 | -1.491E-11 | 4.879E-10 | 1.292E-12 |
| B ₈ | 0.000E+00 | 0.000E+00 | 0.000E+00 | 0.000E+00 | 0.000E+00 |
| r | 0.000E+00 | 0.000E+00 | 0.000E+00 | 0.000E+00 | 0.000E+00 |
| K _{z} | 0.000E+00 | 0.000E+00 | 0.000E+00 | 0.000E+00 | 0.000E+00 |
| E₂ | 0.000E+00 | 0.000E+00 | 0.000E+00 | 0.000E+00 | 0.000E+00 |
| E₄ | 0.000E+00 | 0.000E+00 | 0.000E+00 | 0.000E+00 | 0.000E+00 |
| M ₀₁ | 0.000E+00 | 0.000E+00 | 0.000E+00 | 0.000E+00 | 0.000E+00 |
| M ₂₁ | 0.000E+00 | 0.000E+00 | -1.415E-06 | -3.959E-05 | 3.545E-07 |
| M ₄₁ | 0.000E+00 | 0.000E+00 | 4.548E-10 | -7.294E-09 | 6.574E-11 |
| M ₆₁ | 0.000E+00 | 0.000E+00 | 0.000E+00 | 0.000E+00 | -1.445E-14 |
| M ₀₂ | 1.356E-03 | -1.865E-03 | 3.163E-03 | -4.724E-03 | 3.401E-03 |
| M ₂₂ | 8.716E-09 | -8.702E-07 | 2.354E-07 | -8.732E-07 | -1.760E-10 |
| M ₄₂ | 3.731E-12 | 3.836E-10 | -2.105E-11 | -7.325E-10 | -7.584E-13 |
| M ₆₂ | -2.218E-15 | 4.305E-13 | 0.000E+00 | 0.000E+00 | 1.275E-15 |
| M ₀₃ | 0.000E+00 | 0.000E+00 | -2.048E-06 | -1.691E-05 | -5.178E-07 |
| M ₂₃ | 0.000E+00 | 0.000E+00 | -2.326E-09 | 2.156E-08 | 1.755E-10 |
| M ₄₃ | 0.000E+00 | 0.000E+00 | 2.536E-12 | -2.156E-11 | -5.260E-14 |
| M ₆₃ | 0.000E+00 | 0.000E+00 | 0.000E+00 | 0.000E+00 | 0.000E+00 |
| M ₀₄ | -1.850E-08 | 1.272E-06 | -8.462E-08 | 4.151E-07 | 6.671E-08 |
| M ₂₄ | 7.380E-12 | -1.688E-10 | 2.078E-10 | -2.660E-09 | -3.438E-11 |
| M ₄₄ | -5.049E-15 | -1.559E-12 | -8.106E-15 | -3.242E-12 | 1.870E-14 |
| M ₆₄ | 2.866E-19 | 6.068E-15 | 0.000E+00 | 0.000E+00 | 0.000E+00 |
| M ₀₅ | 0.000E+00 | 0.000E+00 | 0.000E+00 | 0.000E+00 | 1.771E-10 |
| M ₂₅ | 0.000E+00 | 0.000E+00 | 0.000E+00 | 0.000E+00 | -6.137E-13 |
| M ₄₅ | 0.000E+00 | 0.000E+00 | 0.000E+00 | 0.000E+00 | -8.636E-17 |
| M ₆₅ | 0.000E+00 | 0.000E+00 | 0.000E+00 | 0.000E+00 | 0.000E+00 |
| M ₀₆ | -7.656E-13 | -5.490E-10 | 0.000E+00 | 0.000E+00 | -1.224E-11 |
| M ₂₆ | -2.649E-15 | 6.569E-13 | 0.000E+00 | 0.000E+00 | 7.045E-14 |
| M ₄₆ | 1.170E-18 | 6.880E-15 | 0.000E+00 | 0.000E+00 | -2.540E-17 |
| M ₆₆ | 0.000E+00 | 0.000E+00 | 0.000E+00 | 0.000E+00 | 0.000E+00 |

Table 9

| | C1 | C2 | C3 | Reference wavelength | Diffraction order |
|---|---|---|---|---|---|
| Fourth reflective surface | 1.50E-02 | 8.48E-06 | 7.26E-07 | 542 | -1 |

Table 10

| | Diaphragm | Slit member | Light-receiving surface |
|---|---|---|---|
| Diameter (y) | 40 | 30 | 7.2 |
| Diameter (z) | 40 | 0.1 | 5.4 |

### Example 3

An optical system 10 according to example 3 of the disclosure is described below. In the optical system 10 according to the present example, a description of a configuration equivalent to that of the optical system 10 according to example 1 is omitted.

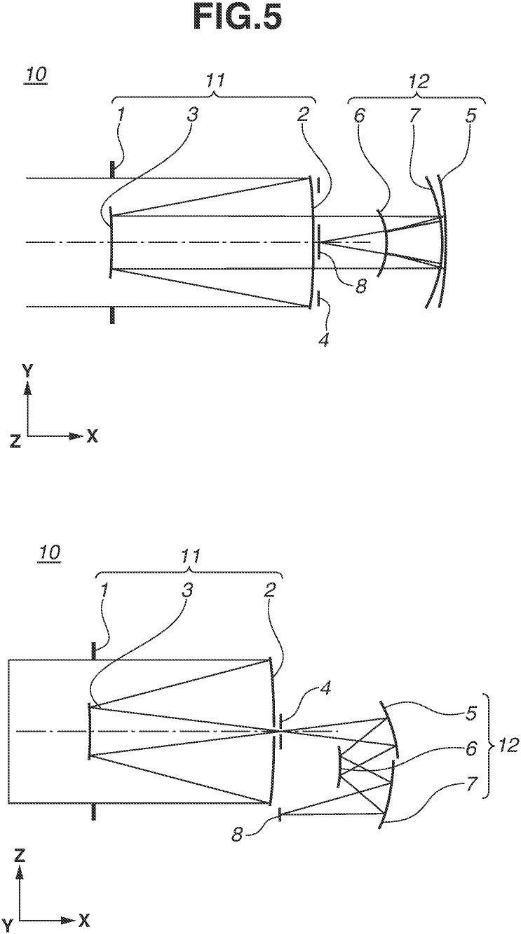

FIG. 5 is a schematic diagram of a main part of the optical system 10 according to the present example. The upper diagram of FIG. 5 illustrates the first cross section, and the lower diagram of FIG. 5 illustrates the second cross section. In the optical system 10 according to the present example, the absolute values of the powers of the reflective surfaces in the rear group 12 are greater than those in example 1, thereby achieving the miniaturization of the rear group 12 while maintaining the focal length comparable to that in example 1.

In the present example, the distance from the object to the diaphragm 1 is 500 km, and the width in the first direction of a reading area is 19.2 km. In the present example, the use wavelength range is from 380 nm to 1120 nm, and the width in the second direction of an image formation area of the light beam on the light-receiving surface 8 is 3.94 mm.

Similarly to example 1, table 11 illustrates the optical characteristics of the optical system 10 according to the present example. Table 12 illustrates the various numerical values of each of the optical surfaces. Table 13 illustrates the surface shapes of the optical surfaces. Table 14 illustrates the various numerical values of the diffractive surface 6. Table 15 illustrates the diameters of the aperture of the diaphragm 1, the aperture of the slit member 4, and the light-receiving surface 8.

Table 11

| | | |
|---|---|---|
| | Reading cross section | Spectral cross section |
| Focal length (image side) | 234.7 | 502.1 |
| | | 890.2 |
| Fno (image side) | 3.0 | 3.8 |
| Image forming magnification | 4.80E-07 | 4.80E-07 |

Table 12

| | | X | Y | Z | θ | d | d′ | R_{y} | R_{z} |
|---|---|---|---|---|---|---|---|---|---|
| Diaphragm | 1 | 85.210 | 0.000 | 0.000 | 0.000 | 124.210 | 124.210 | | |
| First reflective surface | 2 | 39.000 | 0.000 | 0.000 | 180.000 | 126.938 | 126.938 | 431.859 | 344.469 |
| Second reflective surface | 3 | 87.938 | 0.000 | 0.000 | 0.000 | 130.498 | 130.498 | 182.937 | 138.299 |
| Slit member | 4 | 42.560 | 0.000 | 0.000 | 0.000 | 78.067 | 78.408 | | |
| Third reflective surface | 5 | 120.618 | 0.000 | 1.140 | 162.557 | 44.291 | 43.361 | 146.549 | 93.699 |
| Fourth reflective surface | 6 | 84.789 | 0.000 | 24.898 | 0.000 | 39.849 | 40.942 | 29.759 | 65.944 |
| Fifth reflective surface | 7 | 119.018 | 0.000 | 45.303 | 192.056 | 77.057 | 76.088 | 73.817 | 87.799 |
| Light-receiving surface | 8 | 43.375 | 0.000 | 60.000 | -1.413 | | | | |

Table 13

| | | | | | |
|---|---|---|---|---|---|
| | First reflective surface | Second reflective surface | Third reflective surface | Fourth reflective surface | Fifth reflective surface |
| R_{y} | 4.319E+02 | -1.829E+02 | 1.465E+02 | -2.976E+01 | 7.382E+01 |
| K_{y} | 3.762E+00 | -1.602E+00 | -1.000E+00 | -1.000E+00 | -1.000E+00 |
| B₂ | 0.000E+00 | 0.000E+00 | 0.000E+00 | 0.000E+00 | 0.000E+00 |
| B₄ | -5.884E-09 | -8.665E-08 | -1.391E-07 | 2.593E-06 | 1.596E-07 |
| B₆ | 1.076E-13 | -2.643E-12 | -2.318E-11 | -2.529E-10 | 5.188E-12 |
| B₈ | 0.000E+00 | 0.000E+00 | 0.000E+00 | 0.000E+00 | 0.000E+00 |
| r | 0.000E+00 | 0.000E+00 | 0.000E+00 | 0.000E+00 | 0.000E+00 |
| K_{z} | 0.000E+00 | 0.000E+00 | 0.000E+00 | 0.000E+00 | 0.000E+00 |
| E₂ | 0.000E+00 | 0.000E+00 | 0.000E+00 | 0.000E+00 | 0.000E+00 |
| E₄ | 0.000E+00 | 0.000E+00 | 0.000E+00 | 0.000E+00 | 0.000E+00 |
| M ₀₁ | 0.000E+00 | 0.000E+00 | 0.000E+00 | 0.000E+00 | 0.000E+00 |
| M ₂₁ | 0.000E+00 | 0.000E+00 | -5.122E-06 | -6.784E-05 | 1.824E-07 |
| M ₄₁ | 0.000E+00 | 0.000E+00 | 2.233E-09 | -2.188E-07 | -1.171E-09 |
| M ₆₁ | 0.000E+00 | 0.000E+00 | 0.000E+00 | 0.000E+00 | -2.368E-13 |
| M ₀₂ | 1.452E-03 | -3.615E-03 | 5.336E-03 | -7.582E-03 | 5.695E-03 |
| M ₂₂ | -9.637E-10 | -5.891E-07 | 1.231E-06 | -3.982E-06 | -7.200E-08 |
| M ₄₂ | 1.127E-11 | -2.661E-09 | -4.574E-10 | -9.142E-09 | -5.492E-11 |
| M ₆₂ | -5.485E-15 | 8.828E-12 | 0.000E+00 | 0.000E+00 | 3.870E-14 |
| M ₀₃ | 0.000E+00 | 0.000E+00 | -4.883E-06 | -1.853E-05 | 2.367E-06 |
| M ₂₃ | 0.000E+00 | 0.000E+00 | 1.730E-08 | -3.703E-07 | 3.477E-09 |
| M ₄₃ | 0.000E+00 | 0.000E+00 | -4.816E-11 | 3.152E-09 | -6.937E-13 |
| M ₆₃ | 0.000E+00 | 0.000E+00 | 0.000E+00 | 0.000E+00 | 0.000E+00 |
| M ₀₄ | -1.566E-08 | 3.644E-06 | 1.277E-07 | 1.004E-06 | 2.418E-08 |
| M ₂₄ | 4.597E-12 | 7.750E-10 | -5.898E-09 | 8.471E-08 | -2.338E-10 |
| M ₄₄ | -1.453E-14 | 2.825E-11 | 6.429E-12 | -1.606E-10 | 5.109E-13 |
| M ₆₄ | 6.103E-18 | -9.414E-14 | 0.000E+00 | 0.000E+00 | 0.000E+00 |
| M ₀₅ | 0.000E+00 | 0.000E+00 | 0.000E+00 | 0.000E+00 | 1.836E-09 |
| M ₂₅ | 0.000E+00 | 0.000E+00 | 0.000E+00 | 0.000E+00 | 1.341E-11 |
| M ₄₅ | 0.000E+00 | 0.000E+00 | 0.000E+00 | 0.000E+00 | -4.038E-14 |
| M ₆₅ | 0.000E+00 | 0.000E+00 | 0.000E+00 | 0.000E+00 | 0.000E+00 |
| M ₀₆ | -2.354E-12 | -2.232E-09 | 0.000E+00 | 0.000E+00 | -3.020E-10 |
| M ₂₆ | -1.307E-15 | -3.954E-13 | 0.000E+00 | 0.000E+00 | -4.449E-13 |
| M ₄₆ | 3.434E-18 | -5.478E-14 | 0.000E+00 | 0.000E+00 | 1.819E-15 |
| M ₆₆ | 0.000E+00 | 0.000E+00 | 0.000E+00 | 0.000E+00 | 0.000E+00 |

Table 14

| | C1 | C2 | C3 | Reference wavelength | Diffraction order |
|---|---|---|---|---|---|
| Fourth reflective surface | 2.59E02 | -6.64E07 | -1.03E05 | 542 | -1 |

Table 15

| | Diaphragm | Slit member | Light-receiving surface |
|---|---|---|---|
| Diameter (y) | 40 | 30 | 7.2 |
| Diameter (z) | 50 | 0.05 | 5.4 |

### Example 4

An optical system 10 according to example 4 of the disclosure is described below. The optical system 10 according to the present example employs a configuration equivalent to that of the optical system 10 according to the second exemplary embodiment described above.

In the present example, the distance from the object to the diaphragm 1 is 500 km, and the width in the first direction of a reading area is 19.2 km. In the present example, the use wavelength range is from 380 nm to 1120 nm, and the width in the second direction of an image formation area of the light beam on the light-receiving surface 8 is 3.94 mm.

Similarly to example 1, table 16 illustrates the optical characteristics of the optical system 10 according to the present example. Table 17 illustrates the various numerical values of each of the optical surfaces. Table 18 illustrates the surface shapes of the optical surfaces. Table 19 illustrates the various numerical values of the diffractive surface 6. Table 20 illustrates the diameters of the aperture of the diaphragm 1, the aperture of the slit member 4, and the light-receiving surface 8.

Table 16

| | | |
|---|---|---|
| | Reading cross section | Spectral cross section |
| Focal length (image side) | 242.4 | 353.2 |
| | | 2540.1 |
| Fno (image side) | 3.0 | 3.5 |
| Image forming magnification | 4.79E-07 | 4.80E-07 |

Table 17

| | | X | Y | Z | θ | d | d' | R_{y} | R_{z} |
|---|---|---|---|---|---|---|---|---|---|
| Diaphragm | 1 | - 85.210 | 0.000 | 0.000 | 0.000 | 124.210 | 124.210 | | |
| First reflective surface | 2 | 39.000 | 0.00 | 0.000 | 180.000 | 120.140 | 120.140 | 433.027 | 370.676 |
| Second reflective surface | 3 | - 81.140 | 0.000 | 0.000 | -4.800 | 124.489 | 124.489 | - 188.711 | - 276.482 |
| Slit member | 4 | 41.606 | 0.000 | 20.758 | -8.571 | 134.740 | 134.038 | | |
| Third reflective surface | 5 | 174.822 | 0.000 | 40.968 | 154.257 | 74.073 | 72.455 | 270.231 | 159.139 |
| Fourth reflective surface | 6 | 122.016 | 0.000 | - 10.977 | -8.571 | 67.280 | 68.403 | - 49.768 | - 103.816 |
| Fifth reflective surface | 7 | 183.831 | 0.000 | - 37.539 | 185.793 | 132.550 | 134.013 | 118.452 | 144.830 |
| Light-receiving surface | 8 | 53.820 | 0.000 | - 63.362 | -8.571 | | | | |

Table 18

| | | | | | |
|---|---|---|---|---|---|
| | First reflective surface | Second reflective surface | Third reflective surface | Fourth reflective surface | Fifth reflective surface |
| R _{y} | 4.330E+02 | -1.887E+02 | 2.702E+02 | -4.977E+01 | 1.185E+02 |
| K _{y} | -1.907E+00 | -1.607E+01 | -1.000E+00 | -1.000E+00 | -1.000E+00 |
| B ₂ | 0.000E+00 | 0.000E+00 | 0.000E+00 | 0.000E+00 | 0.000E+00 |
| B ₄ | -3.980E-09 | -1.084E-07 | -1.122E-07 | 2.812E-07 | 6.869E-08 |
| B ₆ | 7.950E-13 | -5.825E-11 | 8.496E-12 | 1.553E-10 | 1.122E-12 |
| B ₈ | 0.000E+00 | 0.000E+00 | 0.000E+00 | 0.000E+00 | 0.000E+00 |
| r | 0.000E+00 | 0.000E+00 | 0.000E+00 | 0.000E+00 | 0.000E+00 |
| K _{z} | 0.000E+00 | 0.000E+00 | 0.000E+00 | 0.000E+00 | 0.000E+00 |
| E₂ | 0.000E+00 | 0.000E+00 | 0.000E+00 | 0.000E+00 | 0.000E+00 |
| E₄ | 0.000E+00 | 0.000E+00 | 0.000E+00 | 0.000E+00 | 0.000E+00 |
| M ₀₁ | 0.000E+00 | 0.000E+00 | 0.000E+00 | 0.000E+00 | 0.000E+00 |
| M ₂₁ | 0.000E+00 | 0.000E+00 | -1.229E-06 | -3.810E-05 | 5.148E-07 |
| M ₄₁ | 0.000E+00 | 0.000E+00 | 4.021E-10 | -1.493E-08 | 8.223E-11 |
| M ₆₁ | 0.000E+00 | 0.000E+00 | 0.000E+00 | 0.000E+00 | -2.834E-14 |
| M ₀₂ | 1.349E-03 | -1.808E-03 | 3.142E-03 | -4.816E-03 | 3.452E-03 |
| M ₂₂ | 7.787E-09 | -5.118E-07 | 2.375E-07 | -9.296E-07 | 3.325E-09 |
| M ₄₂ | -4.671E-12 | 1.466E-10 | -5.757E-11 | 2.923E-11 | -2.063E-12 |
| M ₆₂ | 2.579E-15 | -1.940E-13 | 0.000E+00 | 0.000E+00 | -9.623E-17 |
| M ₀₃ | 0.000E+00 | 0.000E+00 | -2.765E-06 | -1.802E-05 | -8.356E-07 |
| M ₂₃ | 0.000E+00 | 0.000E+00 | -2.551E-09 | 4.778E-10 | 3.270E-11 |
| M ₄₃ | 0.000E+00 | 0.000E+00 | 1.695E-12 | 7.768E-11 | -1.091E-13 |
| M ₆₃ | 0.000E+00 | 0.000E+00 | 0.000E+00 | 0.000E+00 | 0.000E+00 |
| M ₀₄ | -2.217E-08 | 1.461E-06 | -2.720E-08 | 1.332E-07 | 6.589E-08 |
| M ₂₄ | 4.192E-12 | -2.141E-09 | 1.830E-10 | -1.368E-09 | -4.616E-12 |
| M ₄₄ | 2.248E-15 | 8.757E-12 | 7.159E-14 | -8.183E-12 | 1.419E-14 |
| M ₆₄ | -3.091E-18 | -6.033E-15 | 0.000E+00 | 0.000E+00 | 0.000E+00 |
| M ₀₅ | 0.000E+00 | 0.000E+00 | 0.000E+00 | 0.000E+00 | 1.243E-09 |
| M ₂₅ | 0.000E+00 | 0.000E+00 | 0.000E+00 | 0.000E+00 | -8.820E-13 |
| M ₄₅ | 0.000E+00 | 0.000E+00 | 0.000E+00 | 0.000E+00 | 8.859E-16 |
| M ₆₅ | 0.000E+00 | 0.000E+00 | 0.000E+00 | 0.000E+00 | 0.000E+00 |
| M ₀₆ | -1.422E-12 | -7.172E-10 | 0.000E+00 | 0.000E+00 | 1.366E-11 |
| M ₂₆ | -3.391E-16 | 4.911E-12 | 0.000E+00 | 0.000E+00 | -2.422E-14 |
| M ₄₆ | 9.744E-19 | -3.182E-14 | 0.000E+00 | 0.000E+00 | -3.449E-18 |
| M ₆₆ | 0.000E+00 | 0.000E+00 | 0.000E+00 | 0.000E+00 | 0.000E+00 |

Table 19

| | C1 | C2 | C3 | Reference wavelength | Diffraction order |
|---|---|---|---|---|---|
| Fourth reflective surface | 1.56E-02 | 8.41E-06 | 3.95E-07 | 542 | -1 |

Table 20

| | Diaphragm | Slit member | Light-receiving surface |
|---|---|---|---|
| Diameter (y) | 40 | 30 | 7.2 |
| Diameter (z) | 40 | 0.2 | 5.4 |

### Example 5

An optical system 10 according to example 5 of the disclosure is described below. The optical system 10 according to the present example employs a configuration equivalent to that of the optical system 10 according to the third exemplary embodiment.

In the present example, the distance from the object to the diaphragm 1 is 500 km, and the width in the first direction of a reading area is 19.2 km. In the present example, the use wavelength range is from 380 nm to 1120 nm, and the width in the second direction of an image formation area of the light beam on the light-receiving surface 8 is 3.94 mm.

Similarly to example 1, table 21 illustrates the optical characteristics of the optical system 10 according to the present example. Table 22 illustrates the various numerical values of each of the optical surfaces. Table 23 illustrates the surface shapes of the optical surfaces. Table 24 illustrates the various numerical values of the diffractive surface 6. Table 25 illustrates the diameters of the aperture of the diaphragm 1, the aperture of the slit member 4, and the light-receiving surface 8.

Table 21

| | | |
|---|---|---|
| | Reading cross section | Spectral cross section |
| Focal length (image side) | 260.7 | 226.4 |
| | | 1313.9 |
| Fno (image side) | 3.0 | 5.4 |
| Image forming magnification | 4.80E-07 | 4.80E-07 |

Table 22

| | | X | Y | Z | θ | d | d' | R_{y} | R_{z} |
|---|---|---|---|---|---|---|---|---|---|
| Diaphragm | 1 | 85.210 | 0.000 0 | 40.000 | 0.000 | 124.612 | 125.824 | | |
| First reflective surface | 2 | 39.000 | 0.000 | -50.000 | 189.444 | 129.468 | 126.859 | 442.157 | 567.435 |
| Second reflective surface | 3 | 80.424 | 0.000 | 0.000 | 7.817 | 122.984 | 123.443 | 188.674 | 1162.774 |
| Slit member | 4 | 42.560 | 0.000 | 0.000 | 0.000 | 135.946 | 134.974 | | |
| Third reflective surface | 5 | 178.506 | 0.000 | 0.000 | 163.893 | 75.425 | 72.985 | 256.529 | 159.814 |
| Fourth reflective surface | 6 | 116.696 | 0.000 | 43.225 | 0.000 | 67.877 | 67.837 | - 46.685 | -98.724 |
| Fifth reflective surface | 7 | 174.653 | 0.000 | 78.557 | 193.375 | 133.172 | 136.101 | 116.667 | 146.595 |
| Light-receiving surface | 8 | 42.814 | 0.000 | 97.356 | -2.725 | | | | |

Table 23

| | | | | | |
|---|---|---|---|---|---|
| | First reflective surface | Second reflective surface | Third reflective surface | Fourth reflective surface | Fifth reflective surface |
| R _{y} | 4.422E+02 | -1.887E+02 | 2.565E+02 | -4.669E+01 | 1.167E+02 |
| K _{y} | 1.064E+01 | -2.795E+01 | -1.000E+00 | -1.000E+00 | -1.000E+00 |
| B ₂ | 0.000E+00 | 0.000E+00 | 0.000E+00 | 0.000E+00 | 0.000E+00 |
| B ₄ | -2.595E-08 | -3.910E-07 | -1.101E-07 | 4.686E-07 | 6.787E-08 |
| B ₆ | 7.376E-13 | 2.468E-10 | -1.039E-11 | 7.118E-10 | 7.740E-13 |
| B ₈ | 0.000E+00 | 0.000E+00 | 0.000E+00 | 0.000E+00 | 0.000E+00 |
| r | 0.000E+00 | 0.000E+00 | 0.000E+00 | 0.000E+00 | 0.000E+00 |
| K _{z} | 0.000E+00 | 0.000E+00 | 0.000E+00 | 0.000E+00 | 0.000E+00 |
| E₂ | 0.000E+00 | 0.000E+00 | 0.000E+00 | 0.000E+00 | 0.000E+00 |
| E₄ | 0.000E+00 | 0.000E+00 | 0.000E+00 | 0.000E+00 | 0.000E+00 |
| M ₀₁ | 0.000E+00 | 0.000E+00 | 0.000E+00 | 0.000E+00 | 0.000E+00 |
| M ₂₁ | 4.563E-07 | 7.782E-06 | -1.630E-06 | -3.193E-05 | 8.133E-07 |
| M ₄₁ | -1.180E-10 | -1.491E-08 | 3.908E-09 | 2.398E-08 | 4.619E-10 |
| M ₆₁ | 9.333E-14 | 1.375E-11 | 0.000E+00 | 0.000E+00 | -1.191E-13 |
| M ₀₂ | 8.812E-04 | 4.300E-04 | 3.129E-03 | -5.065E-03 | 3.411E-03 |
| M ₂₂ | -4.880E-09 | -5.380E-08 | -6.374E-09 | -2.005E-07 | -1.695E-08 |
| M ₄₂ | 3.800E-11 | 3.397E-09 | -3.162E-10 | 1.068E-08 | 3.468E-11 |
| M ₆₂ | -2.026E-15 | -5.465E-12 | 0.000E+00 | 0.000E+00 | -1.880E-14 |
| M ₀₃ | -4.341E-07 | 7.282E-06 | 4.491E-06 | 4.674E-06 | -7.204E-07 |
| M ₂₃ | 1.793E-10 | 2.585E-09 | 1.268E-09 | 6.757E-08 | -1.772E-09 |
| M ₄₃ | 3.137E-13 | 1.848E-11 | -9.392E-12 | -3.465E-10 | 9.694E-13 |
| M ₆₃ | -2.006E-16 | -1.248E-14 | 0.000E+00 | 0.000E+00 | -5.768E-16 |
| M ₀₄ | -2.274E-08 | 4.489E-07 | -8.280E-08 | 2.408E-08 | 5.419E-08 |
| M ₂₄ | 3.067E-11 | -3.777E-10 | 3.196E-10 | -9.897E-10 | 1.558E-11 |
| M ₄₄ | -4.763E-14 | -2.516E-11 | 7.615E-13 | -1.145E-11 | -1.171E-13 |
| M ₆₄ | -3.368E-17 | 3.099E-14 | 0.000E+00 | 0.000E+00 | 0.000E+00 |
| M ₀₅ | -7.309E-10 | 1.645E-08 | 0.000E+00 | 0.000E+00 | -4.572E-10 |
| M ₂₅ | 4.073E-13 | -8.167E-11 | 0.000E+00 | 0.000E+00 | 4.806E-12 |
| M ₄₅ | 8.761E-16 | 1.301E-12 | 0.000E+00 | 0.000E+00 | -8.044E-15 |
| M ₆₅ | -1.392E-18 | -1.021E-15 | 0.000E+00 | 0.000E+00 | 0.000E+00 |
| M ₀₆ | -2.100E-11 | 2.654E-10 | 0.000E+00 | 0.000E+00 | -9.706E-12 |
| M ₂₆ | -5.953E-15 | -3.837E-12 | 0.000E+00 | 0.000E+00 | 1.042E-13 |
| M ₄₆ | 4.239E-17 | 1.258E-13 | 0.000E+00 | 0.000E+00 | -1.472E-16 |
| M ₆₆ | 0.000E+00 | 0.000E+00 | 0.000E+00 | 0.000E+00 | 0.000E+00 |

Table 24

| | C1 | C2 | C3 | Reference wavelength | Diffraction order |
|---|---|---|---|---|---|
| Fourth reflective surface | 1.55E- 02 | 2.98E- 05 | 2.52E- 07 | 542 | -1 |

Table 25

| | Diaphragm | Slit member | Light-receiving surface |
|---|---|---|---|
| Diameter (y) | 35 | 30 | 7.2 |
| Diameter (z) | 40 | 0.05 | 5.4 |

Tables 26, 27, and 28 illustrate the values regarding inequalities (1) to (7) for the optical system 10 according to each of the examples.

Table 26

| | θ1 | θ2 | θ3 | \|θ2 - θ3\| | w2 | w3 | w2/w3 |
|---|---|---|---|---|---|---|---|
| Example 1 | 0.000 | - | - | - | 45.003 | 47.669 | 0.944 |
| Example 2 | 0.000 | - | - | - | 35.936 | 36.439 | 0.986 |
| Example 3 | 0.000 | - | - | - | 32.397 | 31.168 | 1.039 |
| Example 4 | 4.800 | - | - | - | 36.029 | 36.476 | 0.988 |
| Example 5 | 1.628 | 16.780 | 18.210 | 1.430 | 35.362 | 36.072 | 0.980 |

Table 27

| | L1 | L2 | L3 | L1/L2 | L2/L3 |
|---|---|---|---|---|---|
| Example 1 | 17.284 | 102.551 | 135.961 | 0.169 | 0.754 |
| Example 2 | 3.560 | 123.700 | 135.946 | 0.029 | 0.910 |
| Example 3 | 3.560 | 130.498 | 78.067 | 0.027 | 1.672 |
| Example 4 | 20.920 | 124.489 | 134.740 | 0.168 | 0.924 |
| Example 5 | 50.127 | 122.984 | 135.946 | 0.408 | 0.905 |

Table 28

| | φ1 | φ2 | φ2/φ1 | φ3 | φ4 | φ4/φ3 |
|---|---|---|---|---|---|---|
| Example 1 | 0.008 | 0.016 | 2.064 | 0.013 | -0.023 | -1.692 |
| Example 2 | 0.007 | 0.016 | 2.234 | 0.013 | -0.023 | -1.742 |
| Example 3 | 0.013 | 0.025 | 1.943 | 0.022 | -0.036 | -1.620 |
| Example 4 | 0.007 | 0.016 | 2.241 | 0.013 | -0.023 | -1.752 |
| Example 5 | 0.007 | 0.016 | 2.117 | 0.013 | -0.022 | -1.711 |

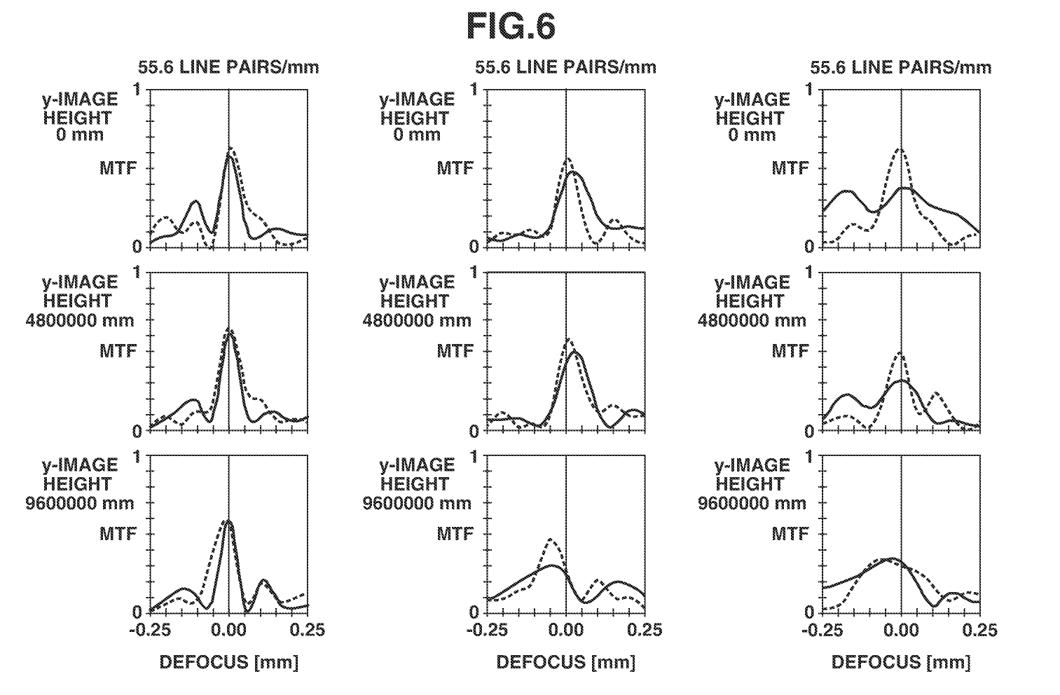

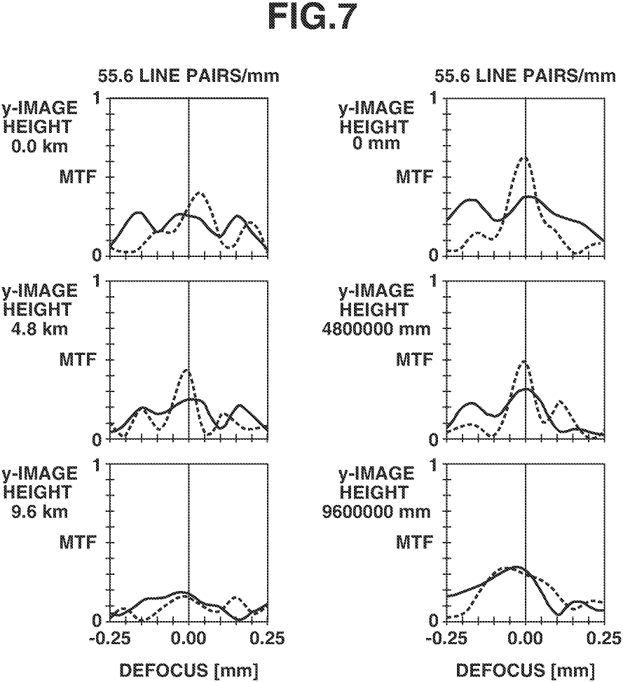

FIGS. 6 and 7 illustrate the modulated transfer function (MTF) of the optical system 10 according to each of the examples. FIGS. 6 and 7 illustrate the MTF at a wavelength of 750 nm in each of the cases where the object height [km] in the reading area is Y = 0.0, 4.8, 9.6. FIG. 6 illustrates the MTF of the optical system 10 according to each of examples 1, 2, and 3 in order from the left. FIG. 7 illustrates the MTF of the optical system 10 according to each of examples 4 and 5 in order from the left. As illustrated in FIGS. 6 and 7, the spatial frequency [line pairs/mm] of the image sensor including the light-receiving surface 8 at a wavelength of 750 nm is 55.6. In FIGS. 6 and 7, a dotted line indicates the MTF of the light beam in the first cross section, and a solid line indicates the MTF of the light beam in the second cross section. As can be seen from FIGS. 6 and 7, in all the examples, aberration is excellently corrected over the entirety of the reading area, and the depth of focus is sufficiently secured.

### Imaging Apparatus and Imaging System

An imaging apparatus (a spectral reading apparatus) and an imaging system (a spectral reading system) as an example of use of the optical system 10 according to each of the above exemplary embodiments are described below.

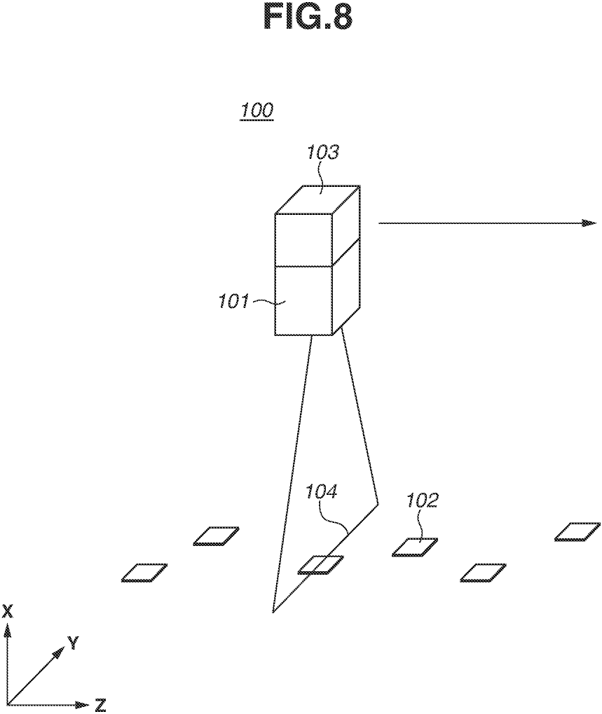

FIG. 8 is a schematic diagram of a main part of an imaging system 100 according to an exemplary embodiment of the disclosure. The imaging system 100 includes an imaging apparatus 101 including an optical system 10 and an image sensor that receives light of an image formed by the optical system 10, and a moving unit (conveyance unit) 103 that changes the relative position of the imaging apparatus 101 and an object 102. In one embodiment, the imaging system 100 includes an image processing unit that generates an image based on image information obtained from the image sensor. The image processing unit is a processor such as a central processing unit (CPU) and may be provided either inside or outside the imaging apparatus 101.

The imaging apparatus 101 captures a line-shaped reading area 104 that is long in the first direction (the Y-direction) once and thereby can acquire a plurality of pieces of image information corresponding to a plurality of wavelengths (a one-dimensional image). At this time, it is desirable to configure the imaging apparatus 101 as a multispectral camera capable of acquiring pieces of image information corresponding to four or more types of wavelengths, which are more than the number of types of wavelengths of a general camera.

Further, it is more desirable to configure the imaging apparatus 101 as a hyperspectral camera capable of acquiring pieces of image information corresponding to 100 or more types of wavelengths.

As the image sensor in the imaging apparatus 101, a charge-coupled device (CCD) sensor or a complementary metal-oxide-semiconductor (CMOS) sensor can be employed. The image sensor may be configured to photoelectrically convert not only visible light but also infrared light (near-infrared light or far-infrared light). Specifically, an image sensor using a material such as InGaAs or InAsSb may be employed according to the use wavelength range. It is desirable to determine the number of pixels of the image sensor based on the resolution required in the reading direction and the spectral direction.

As illustrated in FIG. 8, the moving unit 103 in the imaging system 100 is a unit that moves the imaging apparatus 101 in the second direction (the Z-direction). As the moving unit 103, a drone, a satellite, or an aircraft can be employed. A unit such as a conveyor belt that moves the object 102 in the second direction may be employed as the moving unit 103, where necessary. The moving unit 103 may be configured to move both the imaging apparatus 101 and the object 102. Furthermore, the moving unit 103 may be configured to adjust the relative position of the imaging apparatus 101 and the object 102 in the optical axis direction (the X-direction). Alternatively, a movable optical member (a focus member) may be placed either inside or outside the optical system 10 so that the position of the optical member may be adjusted thereby to focus on the object 102.

Based on the imaging system 100, the imaging apparatus 101 sequentially captures the reading area 104 while the moving unit 103 changes the relative position of the imaging apparatus 101 and the object 102, whereby it is possible to acquire a plurality of pieces of image information corresponding to a plurality of positions in the second direction. The image processing unit rearranges a plurality of captured images or performs a calculation process and thereby can generate a two-dimensional image corresponding to a particular wavelength. Each of the pieces of image information indicates light-and-shade information in the first direction, and therefore, based on pieces of light-and-shade information at respective wavelengths at a particular position in the second direction, the image processing unit may generate spectrum distribution (spectrum information).

### Inspection Method

An inspection method for inspecting an object (an object to be inspected) using the optical system 10 according to each of the above exemplary embodiments is described below.

In a first step (an image capturing step) of the inspection method according to the present exemplary embodiment, an object is captured using the optical system 10, thereby acquiring image information regarding the object. At this time, an imaging apparatus and an imaging system as described above can be used. That is, an image of the object is captured while the relative position of the object and the imaging apparatus is changed, whereby it is possible to acquire image information regarding the entirety of the object.

It is also possible to sequentially (successively) acquire pieces of image information regarding a plurality of objects. In the first step, a plurality of pieces of image information corresponding to the wavelengths of a plurality of light beams emitted from the optical system 10 may be acquired.

In a second step (an inspection step), based on the image information acquired in the first step, the object is inspected. At this time, for example, a user may confirm (determine) the presence or absence of a particular substance in the image information, or a control unit (an image processing unit) may distinguish a particular substance in the image information and notify the user of the particular substance. In the second step, based on the spectrum distribution of the object acquired using a plurality of pieces of image information at respective wavelengths, an environment may be inspected. Using the image information acquired through the optical system 10, it is possible to detect spectrum information specific to the object as the inspection target. This can identify a component of the object. For example, the image processing unit may generate image information by performing highlighting such as coloring with respect to each frequency of the spectrum distribution, and the user may inspect the object based on the image information.

The inspection method according to the present exemplary embodiment is suitable for the inspection (evaluation) of, for example, a natural environment such as vegetation, a stratum, or the atmosphere, a building, or a crop, and can be applied to the environmental field and the industrial field. For example, any area can be inspected by the inspection method described above, and vegetation can be evaluated or a particular resource can be searched for in the inspected area. An agricultural field is inspected in the second step, whereby the user can evaluate the growth state of a crop or predict the amount of production of the crop according to the inspection result.

The inspection method described above may also be applied to a method for manufacturing an article. For example, based on image information regarding an article in a manufacturing process, the presence or absence of a foreign substance or a scratch may be determined, or based on image information regarding a manufacturing apparatus, the presence or absence of an abnormality may be determined. Further, according to these determination results, the foreign substance may be removed, or the driving of the manufacturing apparatus may be stopped, or the abnormality may be corrected.

While various exemplary embodiments and examples of the disclosure have been described above, the disclosure is not limited to these exemplary embodiments and examples, and these exemplary embodiments and examples can be combined, modified, and changed in various ways within the scope of the disclosure.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-148754, filed Sep. 13, 2021, which is hereby incorporated by reference herein in its entirety.

What is claimed is:

1. A system consisting of a front group, a slit member, and a rear group arranged in order from an object side to an image side,
wherein the slit member is provided with an aperture that is long in a first direction,
wherein the front group does not form an image of an object on the aperture in a first cross section parallel to the first direction, and forms an intermediate image of the object on the aperture in a second cross section perpendicular to the first direction,
wherein the rear group includes a diffractive surface configured to disperse a light beam having passed through the aperture into a plurality of rays having wavelengths different from each other in the second cross section and collects the plurality of rays at positions different from each other in the second cross section,
wherein the front group includes a plurality of reflective surfaces having powers in the second cross section,
wherein the plurality of reflective surfaces consists of a first reflective surface configured to reflect a light beam having passed through an aperture of a diaphragm and a second reflective surface configured to reflect the light beam from the first reflective surface, and
wherein the following inequality is satisfied:

|θ1| ≤ 10.0°
where in the second cross section, an extension of a principal ray passing through a center of the aperture of the diaphragm or an optical path of the principal ray is a reference axis and an angle between normals to the first and second reflective surfaces on the reference axis is θ1.

2. The system according to claim 1, wherein the first reflective surface is provided with an aperture through which the light beam reflected by the second reflective surface passes.

3. The system according to claim 2, wherein the aperture of the first reflective surface is provided on the reference axis.

4. The system according to claim 1, wherein the principal ray passes through the aperture of the diaphragm and is blocked by the second reflective surface.

5. The system according to claim 1, wherein the aperture of the slit member is provided on the normal to the first reflective surface.

6. The system according to claim 1, wherein the principal ray is reflected by the first and second reflective surfaces in this order.

7. The system according to claim 6, wherein the following inequality is satisfied:

|θ2 - θ3| ≤ 20.0°
where in the second cross section, a sum of an incidence angle and a reflection angle of the principal ray on the first reflective surface is 62 and a sum of an incidence angle and a reflection angle of the principal ray on the second reflective surface is 63.

8. The system according to claim 1, wherein the following inequality is satisfied:
0.70 ≤ w2/w3 ≤ 1.30
where in the first cross section, a width of the light beam having passed through the aperture of the diaphragm on the second reflective surface is w2 and a width of the light beam on the aperture of the slit member is w3.

9. The system according to claim 1, wherein the following inequality is satisfied:
0.0 ≤ L1/L2 ≤ 0.5
where a distance between a point on the reference axis on the first reflective surface and a center of the aperture of the slit member is L1 and a distance between a point on the reference axis on the second reflective surface and the center of the aperture of the slit member is L2.

10. The system according to claim 1,
wherein the rear group includes a third reflective surface closest to the object on a path in the rear group, and
wherein the following inequality is satisfied:
0.60 ≤ L2/L3 ≤ 1.85
where a distance between a point on the reference axis on the second reflective surface and a center of the aperture of the slit member is L2 and a distance between the center of the aperture of the slit member and a point on the reference axis on the third reflective surface is L3.

11. The system according to claim 1, wherein the rear group includes a third reflective surface, a fourth reflective surface, and a fifth reflective surface configured to reflect the light beam having passed through the aperture of the slit member in order.

12. The system according to claim 11, wherein the following inequality is satisfied:
1.60 ≤ φ2/φ1 ≤ 2.50
where in the first cross section, a power of the third reflective surface is φ1 and a power of the fifth reflective surface is φ2.

13. The system according to claim 11, wherein the following inequality is satisfied:
-2.4 ≤ φ4/φ3 ≤ -1.4
where in the second cross section, a power of the third reflective surface is φ3 and a power of the fourth reflective surface is φ4.

14. The system according to claim 11, wherein in the second cross section, the third reflective surface has a positive power, the fourth reflective surface has a negative power, and the fifth reflective surface has a positive power.

15. An apparatus comprising:
the system according to claim 1; and
a sensor configured to receive light of an image formed by the system.

16. An imaging system comprising:
the apparatus according to claim 15; and
a moving unit configured to change a relative position of the apparatus and the object.

17. A method comprising:
capturing an image of an object using the system according to claim 1 to acquire information regarding the object; and
inspecting the object based on the information.

18. The method according to claim 17, wherein the capturing includes a process of capturing the image of the object while changing a relative position of an apparatus and the object.

19. The method according to claim 17, wherein the capturing includes a process of acquiring a plurality of pieces of information corresponding to the wavelengths of the plurality of rays.

20. The method according to claim 19, wherein the inspecting includes a process of inspecting the object based on spectrum distribution of the object acquired using the plurality of pieces of information.
